(19) United States
(12) Patent Application Publication
(10) Pub. No.: US 2024/0424398 A1
(43) Pub. Date: Dec. 26, 2024

(54) FUSED MULTIMODAL FRAMEWORK FOR NON-PLAYER CHARACTER GENERATION AND CONFIGURATION

(71) Applicant: ADVANCED MICRO DEVICES, INC., Santa Clara, CA (US)

(72) Inventors: Karthik Mohan Kumar, San Jose, CA (US); Michael Mantor, Orlando, FL (US); Pedro Antonio Pena, Orlando, FL (US); Archana Ramalingam, Bellevue, WA (US)

(21) Appl. No.: 18/748,920

(22) Filed: Jun. 20, 2024

Related U.S. Application Data
(60) Provisional application No. 63/521,977, filed on Jun. 20, 2023.

(51) Int. Cl. A63F 13/56; A63F 13/67; G06T 13/20; G06T 13/40

(52) U.S. Cl. CPC A63F 13/56; A63F 13/67; G06T 13/205; G06T 13/40; G06T 2210/52

(57) ABSTRACT

Systems and techniques for generating and animating non-player characters (NPCs) within virtual digital environments are provided. Multimodal input data is received that comprises a plurality of input modalities for interaction with an NPC having a set of body features and a set of facial features. The multimodal input data is processed through one or more neural networks to generate animation sequences for both the body features and facial features of the NPC. Generating such animation sequences includes disentangling the multimodal input data to generate substantially disentangled latent representations, combining these representations with the multimodal input data, and using a large-language model (LLM) to generate speech data for the NPC. Further processing using reverse diffusion generates face vertex displacement data and joint trajectory data based on the combined representation and generated speech data. The face vertex displacement data, joint trajectory data, and speech data are used to produce an animated representation of the NPC, which is then provided to environment-specific adapters to animate the NPC within a virtual digital environment.

### BACKGROUND

The present invention relates generally to the field of artificial intelligence (AI) and gaming technology. More specifically, the invention relates to non-player characters (NPCs) in video games and other virtual digital environments.

Non-Player Characters (NPCs) are crucial elements in modern video games, digital environments, and various forms of virtual realities (all interchangeably referred to herein as virtual digital environments). They contribute to the narrative aspect of games and significantly influence the user gameplay experience. Conventionally, NPCs are characters in video games that are not controlled by a user. Instead, they are programs designed to display a set of animations and engage in pre-scripted conversations to assist a user in comprehending the storyline or navigating them through a game level. These characters often serve as guides, adversaries, bystanders, or quest-givers in games.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system designed to implement fused NPC generation, in accordance with one or more embodiments.

FIG. 2 illustrates an overview of a neural network based NPC generation system designed to implement fused NPC generation, in accordance with one or more embodiments.

FIG. 3 illustrates the distinction between unimodal dependency and the multimodal approach of a multimodal contextualizer (MMC) in accordance with some embodiments.

FIGS. 4 and 5 illustrate successive training phases of an MMC, in accordance with some embodiments.

FIG. 6 illustrates a multimodality disentanglement process within an MMC, in accordance with some embodiments.

FIG. 7 illustrates a codebook optimization process for optimized multimodal translation, in accordance with some embodiments.

FIG. 8 illustrates the architecture of an adaptive multimodal fuser (AMMF), in accordance with some embodiments.

FIG. 9 provides a detailed view of a Mixture of Experts (MoE) Encoder block used within an AMMF, in accordance with some embodiments.

FIG. 10 illustrates an example architecture for a Large Language Model (LLM) in accordance with some embodiments.

FIG. 11 illustrates an example structure and operations of an NPC-AI model in accordance with some embodiments.

FIG. 12 illustrates an additional view of the NPC generation system illustrated in FIG. 2, in accordance with some embodiments.

FIG. 13 illustrates an operational flow diagram of a training process for embodiments of an NPC generation system, in accordance with some embodiments.

FIG. 14 illustrates an operational flow diagram for a multimodal contextualizer, in accordance with some embodiments.

FIG. 15 illustrates an operational flow diagram for an adaptive multimodal fuser, in accordance with some embodiments.

FIG. 16 illustrates a flow diagram of an operational routine 1600 for generating an animated representation of a character model, in accordance with one or more embodiments.

FIG. 17 illustrates a flow diagram of an operational routine for generating an animated representation of an NPC within a virtual digital environment, in accordance with one or more embodiments.

### DETAILED DESCRIPTION

Previous approaches for generating Non-Player Characters (NPCs) result in those NPCs having limited capabilities, as they are typically based on predefined scripts and lack dynamic interaction. As a result, such characters cannot interact with other virtual characters or humans in the digital space in real-time or provide context-aware responses. Moreover, their facial and body animations are typically generic and do not react realistically to in-game situations or user inputs.

Additionally, conventional methods of animating NPCs often involve separate models for the face and body, leading to challenges in unifying these animations to achieve a cohesive character representation. Current solutions do not establish an implicit relationship between face and body animation and do not sufficiently solve the disentangled problem.

Furthermore, the traditional methods of creating and animating NPCs are not optimized for different hardware systems, leading to performance issues and limitations on the complexity and quantity of NPCs that can be rendered in real-time.

Conventional NPCs also typically intake a limited number of modes, such as vision and language, to reason about a virtual digital environment and generate consistent behavior. (As used herein, the terms mode and modality are used interchangeably to generally refer to different types of input data for processing.) Current models for animation utilize unimodal or bimodal approaches, such as vision-language models (VLMs), to generate visual-textual representations that drive animation generation. However, these VLMs do not capture the nuances in language necessary to express motions and emotions required for realistic animation. Complex virtual digital environments, such as metaverses and multiplayer games, require enhanced contextual representations to drive animations sensitive to environmental subtleties. Multiple levels of interaction are essential for understanding the underlying mechanisms of a virtual digital environment to generate appropriate animations.

Moreover, traditional approaches to NPC generation often involve separately processing data through each layer of the neural network and then combining the results. This method can be inefficient and computationally expensive. As a result, there is a need for a more efficient approach to processing data via generative artificial intelligence (generative AI) architectures that reduces memory operations and improves computational efficiency. Furthermore, the cross-environment adaptation of NPCs, such as integrating them into different game engines, remains a non-trivial task, posing additional challenges to their widespread adoption and functionality.

Techniques described herein provide improved systems and methods for creating, animating, and controlling NPCs that are capable of complex, interactive conversations in video games and other virtual digital environments. In certain embodiments, the described techniques are driven by one or more convolutional and/or other neural networks, and are enabled thereby to generate NPCs that react realistically to the game environment and player interactions, providing a more immersive and interactive experience for users.

In certain embodiments, the techniques enable generation of one or more AI-driven NPCs, each of which uses multiple modes of input, including text and audio, to execute interactions. The NPC is designed to generate appropriate responses based on spoken or written language and to display context-based realistic facial and body animations. The system creates an implicit relationship between face and body animation through a unified architecture, thereby addressing the disentangling problem frequently observed in conventional NPC designs.

Various embodiments implement a diffusion-based NPC-AI model targeted at face and body animation, along with an application of a diffusion-based model to 3D faces. This allows for broad cross-environmental applications such as the animation of personalized 3D faces, game engine characters, and more. As used herein, diffusion-based refers to processes or methods that utilize probabilistic modeling techniques to iteratively refine data representations by introducing and removing noise. In particular, diffusion-based models operate by gradually adding noise to data through a forward diffusion process, and then learning to reverse this process to recover the original data or generate new data by denoising. Thus, reverse diffusion refers to a probabilistic process that iteratively refines noisy data representations into coherent and detailed outputs by reversing the diffusion of noise through a trained neural network to progressively enhance the quality of the data. In the context of the NPC-AI model, reverse diffusion is employed to transform initial noisy inputs into high-fidelity face vertex displacement data and joint trajectory data, which are used to generate realistic and contextually accurate animations for non-player characters (NPCs). This approach allows for the generation or reconstruction of high-fidelity data across various modalities, including text, images, and audio.

In addition, certain embodiments utilize dynamic emotion and motion guidance, controlling the realistic expressions of the face and body using textual descriptions of emotions and actions. Such embodiments utilize a fusion of audio and text inputs to generate dynamic high-fidelity motion sequences and expressive talking faces. Furthermore, it employs an emotion and action-oriented contrastive language model that powers downstream animation models.

In certain embodiments, an NPC Software Development Kit (SDK) is provided that can be seamlessly integrated into game engines and a variety of virtual digital environments. This SDK leverages a unified AI architecture to generate responses for both body and face animations using the same multimodal inputs. Additionally, certain embodiments enable generation of environment-driven NPC agents that depict native representations of the NPC model, such as face vertices and joint rotations. Certain embodiments also provide multi-environment models/plugins/SDKs/tools to adapt these native NPC representations for downstream applications.

In various embodiments, the described techniques are utilized via a range of applications, including game character control, interactive assistants, video teleconferencing, metaverse environments, and entertainment.

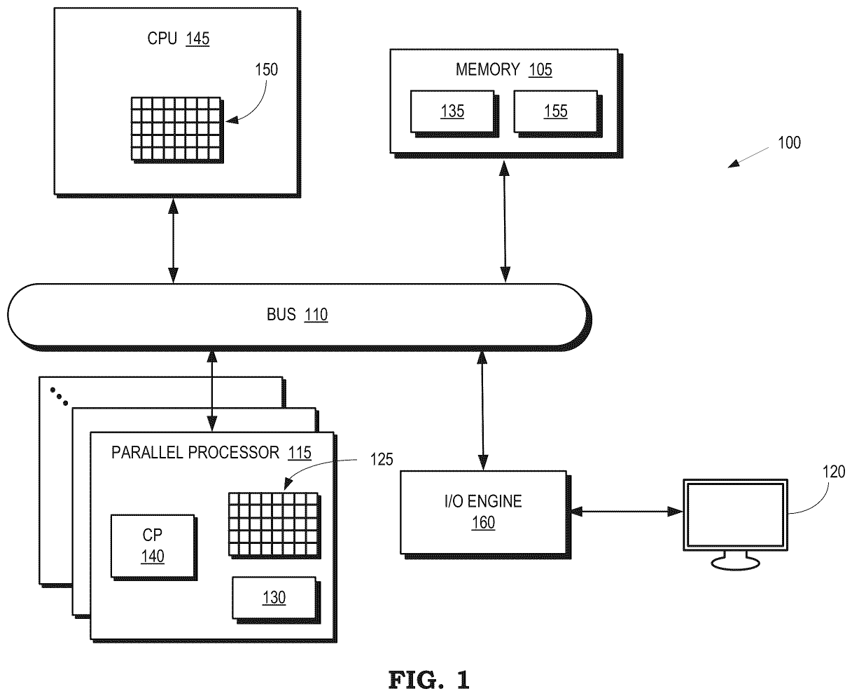

FIG. 1 is a block diagram of a processing system 100 designed to implement fused NPC generation and configuration based on multimodal inputs in accordance with one or more embodiments. The processing system 100 is generally designed to execute sets of instructions or commands to carry out tasks on behalf of an electronic device, such as a desktop computer, laptop computer, server, smartphone, tablet, game console, and the like.

The processing system 100 includes or has access to a memory 105 or other storage component that is implemented using a non-transitory computer readable medium, such as dynamic random access memory (DRAM). The processing system 100 also includes a bus 110 to support communication between entities implemented in the processing system 100, such as the memory 105. In certain embodiments, the processing system 100 includes other buses, bridges, switches, routers, and the like, which are not shown in FIG. 1 in the interest of clarity.

The processing system 100 includes one or more parallel processors 115 that are configured to render images for presentation on a display 120. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 115 can render objects to produce pixel values that are provided to the display 120. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 115 is also used for general-purpose computing. For instance, the parallel processor 115 can be used to implement machine learning algorithms such as one or more implementations of a neural network as described herein. In some cases, operations of multiple parallel processors 115 are coordinated to execute a machine learning algorithm, such as if a single parallel processor 115 does not possess enough processing power to run the machine learning algorithm on its own.

The parallel processor 115 implements multiple processing elements (also referred to as compute units) 125 that are configured to execute instructions concurrently or in parallel. The parallel processor 115 also includes an internal (or on-chip) memory 130 that includes a local data store (LDS), as well as caches, registers, or buffers utilized by the compute units 125. The parallel processor 115 can execute instructions stored in the memory 105 and store information in the memory 105 such as the results of the executed instructions. The parallel processor 115 also includes a command processor 140 that receives task requests and dispatches tasks to one or more of the compute units 125.

The processing system 100 also includes a central processing unit (CPU) 145 that is connected to the bus 110 and communicates with the parallel processor 115 and the memory 105 via the bus 110. The CPU 145 implements multiple processing elements (also referred to as processor cores) 150 that are configured to execute instructions concurrently or in parallel. The CPU 145 can execute instructions such as program code 155 stored in the memory 105 and the CPU 145 can store information in the memory 105 such as the results of the executed instructions.

An input/output (I/O) engine 160 handles input or output operations associated with the display 120, as well as other elements of the processing system 100 such as keyboards, mice, printers, external disks, and the like. The I/O engine 160 is coupled to the bus 110 so that the I/O engine 160 communicates with the memory 105, the parallel processor 115, or the CPU 145.

In operation, the CPU 145 issues commands to the parallel processor 115 to initiate processing of a kernel that represents the program instructions that are executed by the parallel processor 115. Multiple instances of the kernel, referred to herein as threads or work items, are executed concurrently or in parallel using subsets of the compute units 125. In some embodiments, the threads execute according to single-instruction-multiple-data (SIMD) protocols so that each thread executes the same instruction on different data. The threads are collected into workgroups (also termed thread groups) that are executed on different compute units 125. For example, the command processor 140 can receive these commands and schedule tasks for execution on the compute units 125.

In some embodiments, the parallel processor 115 implements a graphics pipeline that includes multiple stages configured for concurrent processing of different primitives in response to a draw call. Stages of the graphics pipeline in the parallel processor 115 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene.

As used herein, a layer in a neural network is a hardware- or software-implemented construct in a processing system, such as processing system 100. In various embodiments, such a layer may perform one or more operations via processing circuitry of the processing system 100 to serve as a collection or group of interconnected neurons or nodes, arranged in a structure that can be optimized for execution on one or more parallel processors (e.g., parallel processors 115) or other similar computation units. Such computation units can, in certain embodiments, comprise one or more graphics processing units (GPUs), massively parallel processors, single instruction multiple data (SIMD) architecture processors, and single instruction multiple thread (SIMT) architecture processors.

Each layer processes and transforms input data for example, raw data input into an input layer or the transformed data passed between hidden layers. This transformation process involves the use of an output weight matrix, which is held in memory (e.g., memory 105) and manipulated by the central processing unit (CPU) 145 and/or the parallel processors 115.

In some instances, such layers may be distributed across multiple processing units within a system. For instance, different layers or groups of layers may be executed on different compute units 125 within a single parallel processor 115, or even across multiple parallel processors if warranted by system architecture and the complexity of the neural network.

The output of each layer, after processing and transformation, serves as input for the subsequent layer. In the case of the final output layer, it produces the results or predictions of the neural network. In various embodiments, such results can be utilized by the system or fed back into the network as part of a training or fine-tuning process. In some embodiments, the training or fine-tuning process involves adjusting one or more weights in the output weight matrix associated with each layer to improve performance of the neural network.

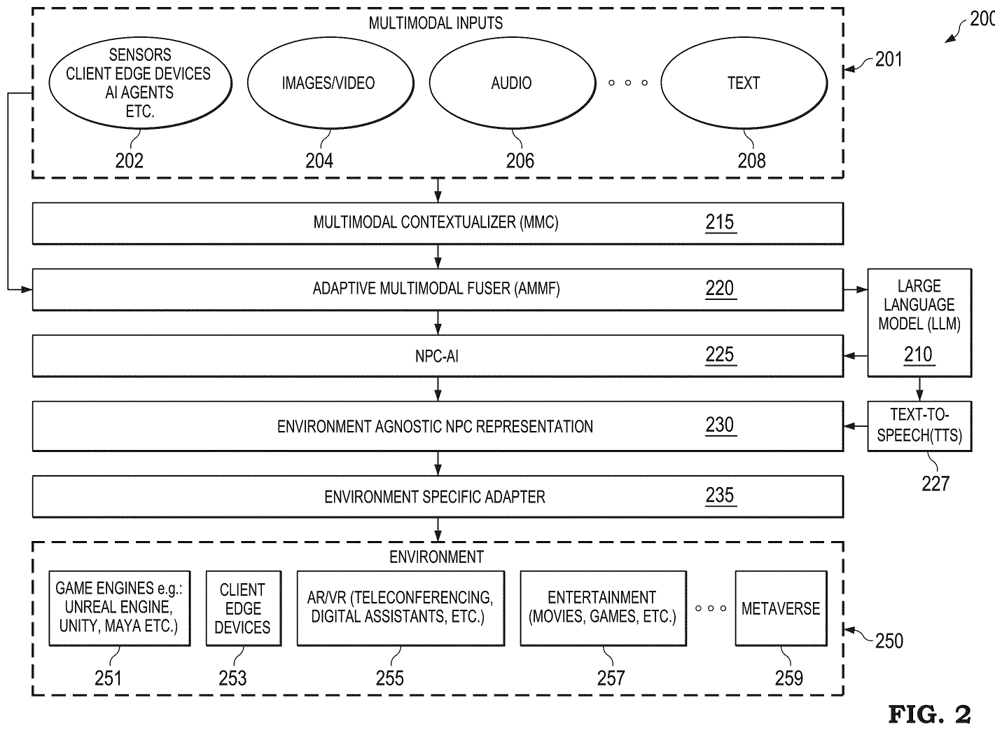

FIG. 2 illustrates an overview of the NPC generation system 200, demonstrating the flow from multimodal inputs to an environment-specific representation of a generated NPC, in accordance with some embodiments. In certain embodiments, the NPC generation system 200 executes via a parallel processing system such as the processing system 100 of FIG. 1. The NPC generation system 200 integrates various components to facilitate the generation of context-aware and dynamic NPCs. The flow includes a Multimodal Contextualizer (MMC) 215, an Adaptive Multimodal Fuser (AMMF) 220, a large language model (LLM) 210, a text-to-speech (TTS) module 227, and one or more environment-specific adapters 235.

A collection of multimodal inputs 201 includes one or more inputs of varying types. In the depicted embodiment, the multimodal inputs 201 include one or more of sensor input data 202, graphical input data 204, audio input data 206, and textual input data 208. In various embodiments, the sensor input data 202 includes information collected from a wide array of sensors, which may be embedded in client edge devices, utilized by AI agents, or integrated into interactive virtual digital environments. This data includes, in various implementations, physical measurements such as temperature, motion, proximity, and other environmental variables for NPC context. Additionally, sensor input data 202 might include more complex data types such as biometric, geographical, or physiological metrics. Along with graphical input data 204, audio input data 206, and textual input data 208, these inputs form the initial data layer that feeds into higher processing modules within the system.

The multimodal inputs 201 are processed by the MMC 215, which generates emergent cross-modal latent representations by substantially disentangling mode pairings, as described in greater detail elsewhere herein. As used herein, a latent representation refers to a high-dimensional encoding of input data, which captures the features and underlying structure of the data. In embodiments of techniques described herein, this encoding is used to facilitate various processing tasks such as disentanglement, translation, and reconstruction by the MMC 215. The latent representation serves as a compact and informative summary of the input data, enabling efficient manipulation and analysis of complex multimodal inputs. The MMC 215 connects disparate input modes by translating between mode representations in a categorical latent space without any need to bind the input modes to a common modality, such as in previous approaches.

The generated representations from the MMC 215 are then passed to the AMMF 220. The AMMF 220 fuses these multimodal representations through a heterogeneous mixture of experts (MoE), each processing different modes and combining them into a cohesive representation. (As used herein, a MoE is a neural network in which a set of parameters are partitioned into disparate expert layers, as discussed in greater detail elsewhere herein.) In certain embodiments, the AMMF 220 enhances the representation by leveraging diverse architectures such as state-space models (SSM), multilayer perceptrons (MLP), and cross-attention mechanisms, resulting in an optimized and enriched context for downstream tasks.

The output from the AMMF 220 conditions a large language model (LLM) 210, which provides the NPC system with context for conversational responses, motion descriptors, and emotion descriptors. The LLM 210 embeddings condition the NPC-AI model 225 and provides input for the TTS block 227, guiding the generation of face and body animations that align with the input data's contextual information. The TTS block 227 converts the textual responses generated by the LLM 210 into speech, enhancing the NPC's interactive capabilities by providing audible responses or other audible linguistic output.

The NPC-AI model 225, which in some embodiments is at least partially structured as a one-dimensional (1D) U-Net with transformer blocks and multi-head attention blocks, performs a reverse diffusion process, transforming noise (such as Gaussian noise) into face and body animation sequences. As used herein, a U-Net refers to a type of neural network architecture that is characterized by a substantially symmetric U-shaped structure. This architecture includes an encoder path that progressively captures context by down-sampling the input data, and a decoder path that reconstructs the output by up-sampling. The encoder and decoder paths are connected by skip connections that transfer detailed information from the encoder to the corresponding layers in the decoder, enhancing the reconstruction quality. In various embodiments of the NPC-AI model, a U-Net is utilized to iteratively refine noisy data into detailed and high-fidelity face vertex displacement data and joint trajectory data for generating realistic animations based on input from both the AMMF 220 and the LLM 210, integrating multimodal contextual data and language-based conditioning.

The environment-agnostic NPC representation 230, which includes data such as face vertices and joint rotations, is then adapted by one or more environment-specific adapters 235. Generally, each of the environment-specific adapters 235 converts the native NPC representations into a format suitable for one of various downstream applications, including game engines 251, client edge devices 253, augmented reality (AR) and virtual reality (VR) systems 255, entertainment platforms 257, and meta-verse applications 259. These converted and environment-specific representations may be considered the output of the NPC generation system 200, enabling the generated NPC to interact within the designated virtual digital environment. The flow from multimodal inputs to environment-specific NPC representation illustrates the capability of the system 200 to generate dynamic, context-aware NPCs that enhance user interaction and engagement in virtual digital environments.

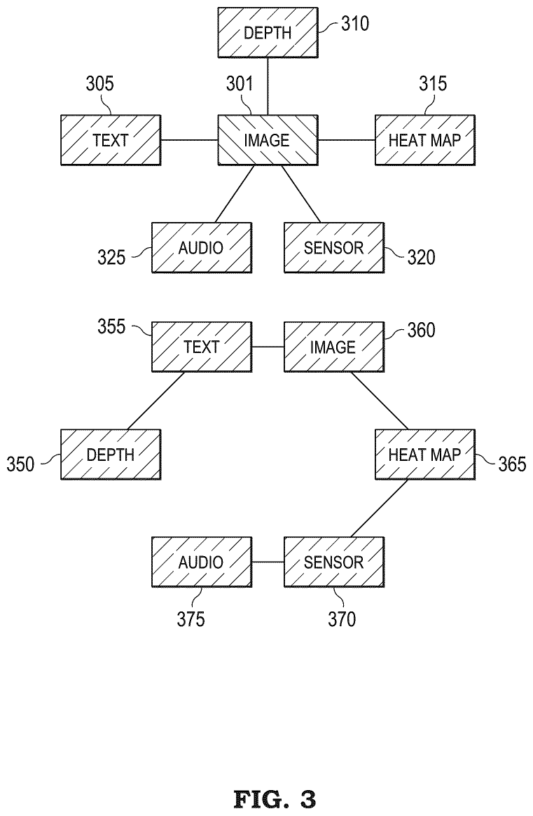

FIG. 3 illustrates the distinction between traditional unimodal dependency and the multimodal approach taken by MMC 215, in accordance with some embodiments. The top portion of FIG. 3 shows a conventional unimodal dependent method, while the bottom portion shows the MMC approach.

In the conventional method depicted in the top diagram, multimodal data is bound to a common modality, typically images. The image data 301 acts as the central modality, interfacing with various other modes:
Textual data 305
Depth data 310
Heat map data 315
Sensor data 320
Audio data 325

This configuration requires all other modalities to be paired with image data 301, which can lead to inefficiencies and limitations when such pairings are unavailable or inadequate.

In contrast, the bottom diagram of FIG. 3 demonstrates the MMC approach, which eliminates the necessity for a single common modality. Instead, the MMC 215 facilitates direct connections between neighboring modalities, allowing for more efficient cross-modal retrieval and enhanced contextual understanding. As one example, in various scenarios and embodiments the MMC approach may utilize the following modality pairings:
Textual data 355 paired with Image data 360
Image data 360 paired with Heat map data 365
Heat map data 365 paired with Sensor data 370
Sensor data 370 paired with Audio data 375
Audio data 375 paired with Depth data 350
Depth data 350 paired with Textual data 355

This direct mode pairing allows the system to leverage direct relationships between neighboring modalities, generating more accurate and comprehensive representations without being constrained by a single central modality. By substantially disentangling modality pairings in this manner, the MMC 215 can more effectively drive downstream tasks and improve overall system performance. It will be appreciated that the pairings noted above are merely one exemplary permutation, and that in various embodiments and scenarios other modality pairings may be utilized by the MMC 215.

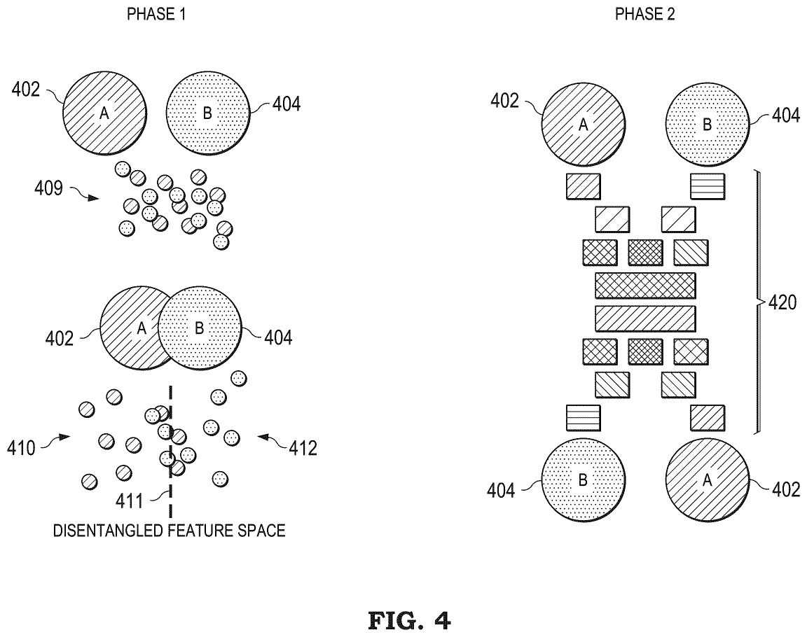

FIG. 4 illustrates successive training phases of the MMC 215, demonstrating a process of substantial bi-modal disentanglement and cross-modal translation to generate efficient multimodal representations, in accordance with some embodiments.

In phase 1, as depicted on the left side of FIG. 4, the MMC 215 processes input modalities to learn a disentangled feature space, taking pairs of various modalities and training them without being bound by a single modality. The input modalities include input modality A 402 and input modality B 404, which represent any pair of modalities (e.g., text and image, depth map and heat map, text and sensor data, etc.). The input modalities 402 and 404 are initially entangled with other features (as represented by entangled feature space 409), such that their combined representations make it difficult to distinguish between the specific contributions of each modality. In other words, the features from different modalities (e.g., audio, visual, textual) are intertwined in a single representation, making it challenging to isolate the unique characteristics and information provided by each modality. Disentangling these representations separates the features and information specific to each modality into distinct, individual representations, transforming the entangled representation into modality-specific latent spaces where the unique aspects of each input mode can be analyzed and processed independently.

Through the disentanglement process, the system learns to separate these modalities into distinct features within a substantially disentangled feature space 411, resulting in separate clusters 410 (mode A) and 412 (mode B) for each modality. This substantial disentanglement allows the MMC 215 to handle each modality independently while preserving the essential features of each input.

In certain embodiments, the MMC 215 utilizes one or more pre-trained encoders to convert the multimodal input data 201 into respective latent representations for each input modality of the plurality of input modalities. In various scenarios, these pre-trained encoders are established models that have been extensively trained on large datasets specific to each modality, ensuring their robustness and reliability. As one example, for text modalities, the pre-trained encoders might be based on models that have been trained on vast text corpora to understand and generate human language effectively. As another example, for image modalities convolutional neural networks (CNNs) that are trained on large image datasets (e.g., ImageNet), are used to capture intricate visual features. Audio data can be processed using transformer-based architectures that have been trained on extensive audio datasets to accurately represent and generate sound patterns. For sensor data, specialized models trained on relevant sensor datasets are utilized to encode the input data into meaningful latent representations.

By leveraging these pre-trained encoders, the MMC 215 can efficiently and accurately encode the multimodal input data 201 into high-dimensional latent representations that capture the essential features and structure of each modality. This initial encoding provides a robust foundation for disentangling and translating the multimodal data, and allows the MMC 215 to build on the strengths of existing, well-established models. The pre-trained encoders ensure that the input data from each modality is represented in a way that preserves its unique characteristics while enabling effective integration with data from other modalities.

Phase 2 is depicted on the right side of FIG. 4 and depicts the further processing of the substantially disentangled features to establish an inter-modality relationship. Cross-modal retrieval is enabled, using modality-specific pre-trained encoders from phase 1 to generate a representation for each mode and to train a transformer-based architecture to translate between different mode representations using reconstruction loss. For example, given two modes, mode A 402 and mode B 404, a phase 2 A-B translation transformer 420 takes an A/B latent representation and maps into a B/A latent representation. The translation transformer 420 learns the interactions between mode A 402 and mode B 404 via a structured mapping of features, ensuring that the contextual relationships between modalities are accurately captured. This phase enables the MMC 215 to generate coherent and contextually relevant outputs when faced with inputs of different modalities.

As used herein, a reconstruction loss refers to a measure of how well a model's output matches the original input data, quantifying the difference between the original input and the reconstructed output produced by the model after encoding and decoding processes. In certain embodiments, this reconstruction loss is used as an objective function during training to guide the optimization of the model's parameters, ensuring that the encoded latent representations capture the essential features and structure of the input data accurately. A lower reconstruction loss indicates a more accurate reconstruction, which implies better performance of the model in preserving the original information through its latent representations.

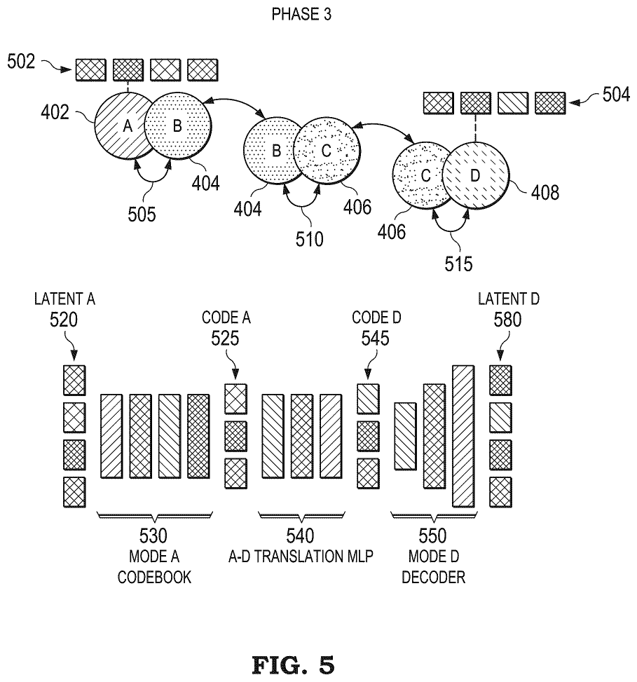

FIG. 5 continues the training phases of the MMC 215 from FIG. 4, and in particular illustrates phase 3 of such training, which develops a vector-quantized cross-modal translation between different input modalities. This phase enhances the capability of the NPC generation system 200 to generate efficient and accurate multimodal representations.

In phase 3, the process begins with the latent representations of various modes determined in phases 1 and 2, starting with latent mode-A representations 520. These latent mode-A representations 520 are encoded into a mode-specific codebook, such as the mode-A codebook 530. Each codebook stores quantized representations of the latent features specific to its corresponding mode, facilitating efficient and accurate translation between different modes.

The translation process involves an A-D Translation MLP 540, which bridges between latent mode-A representations 520 and latent mode-D representations 580. This MLP architecture enables direct translation between these modes, utilizing the quantized codes stored in their respective codebooks. The output from the A-D Translation MLP 540 is then decoded by the mode D decoder 550 into latent mode-D representations 580. This decoding process generates latent representations that maintain the essential features and context of the original mode A, but in the form of mode D. By leveraging the vector-quantized translation and codebook mechanism of the A-D translation MLP 540, phase 3 of the MMC training substantially optimizes the translation between various multimodal input pairs, improving overall contextual understanding and output quality.

The top portion of FIG. 5 depicts the interaction between different modalities during the vector-quantized translation. These include modality A 402, modality B 404, modality C 406, and modality D 408. The cross-modal translations are shown as successive interactions between these modalities: the translation 505 from modality A 402 to modality B 404, translation 510 from modality B 404 to modality C 406, and translation 515 from modality C 406 to modality D 408. The top portion of FIG. 5 illustrates the sequential processing of these modal translations. The initial mode-A inputs 502 undergo translations through the successive intermediate translations 505, 510, 515, ultimately resulting in a coherent mode-D representation 504.

The multi-phase approach depicted in FIGS. 4 and 5 enables the MMC 215 to generate enhanced multimodal representations by efficiently disentangling and translating between modalities. The resulting representations are both accurate and contextually rich, providing a robust foundation for downstream tasks.

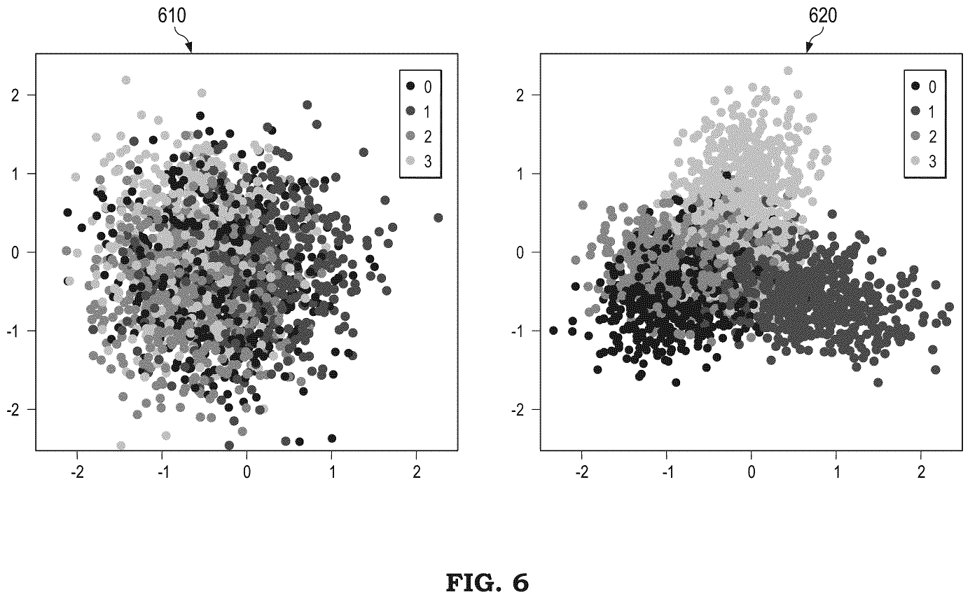

FIG. 6 illustrates results of the disentanglement process by the MMC 215, depicting the transformation of multimodal data from a continuous latent space 610 to a categorical latent space 620, in accordance with some embodiments.

On the left-hand side of FIG. 6, the continuous latent space 610 is depicted. This space represents the initial state of the multimodal data, where features from various input modalities are intermingled. In this continuous latent space 610, the data points lack clear boundaries and are not yet optimized for efficient cross-modal translation or retrieval. Inset legends are included with categorical labels (presented vertically as “0 1 2 3” from top to bottom, respectively) representing discrete categories or clusters, indicating how the data points are categorized within the space. The continuous latent space 610 captures the raw, high-dimensional representations of the input modalities, which include various forms such as text, images, audio, and sensor data.

The right-hand side of FIG. 6 illustrates the categorical latent space 620. This space represents the transformed state of the multimodal data after undergoing the disentanglement process. In the categorical latent space 620, the features are organized into substantially discrete, well-defined clusters, each corresponding to a specific mode or modality. This transformation enables the MMC 215 to efficiently handle and process each modality independently while preserving the essential features and context of the original input data. The categorical latent space 620 facilitates the generation of more accurate and contextually relevant multimodal representations, which significantly improve both accuracy and performance for downstream tasks such as NPC generation and interaction.

In phase 3, after training the MMC to predict one mode from another, translation can lead to a time-consuming path from one mode to another. For example, to transition from mode A 402 to mode D 408, sequential bimodal translation is performed via intermediate modes B 404 and C 406. This sequential bimodal translation may be undesirable in some applications due to inefficiency. To address this, the MMC 215 utilizes a codebook optimization process, which allows direct translation between modes by sampling the sequential bimodal translation trajectories and vector-quantizing a mode accordingly. As used herein, vector quantization of a mode refers to mapping high-dimensional data representations into a finite set of discrete, lower-dimensional vectors as codebook entries. Such quantization reduces the complexity of the data by representing similar data points with a common code, thus facilitating efficient storage, retrieval, and translation between different modes. In the context of the MMC, vector quantization allows for more efficient and accurate cross-modal translations by using these quantized vectors to represent the latent features of each mode.

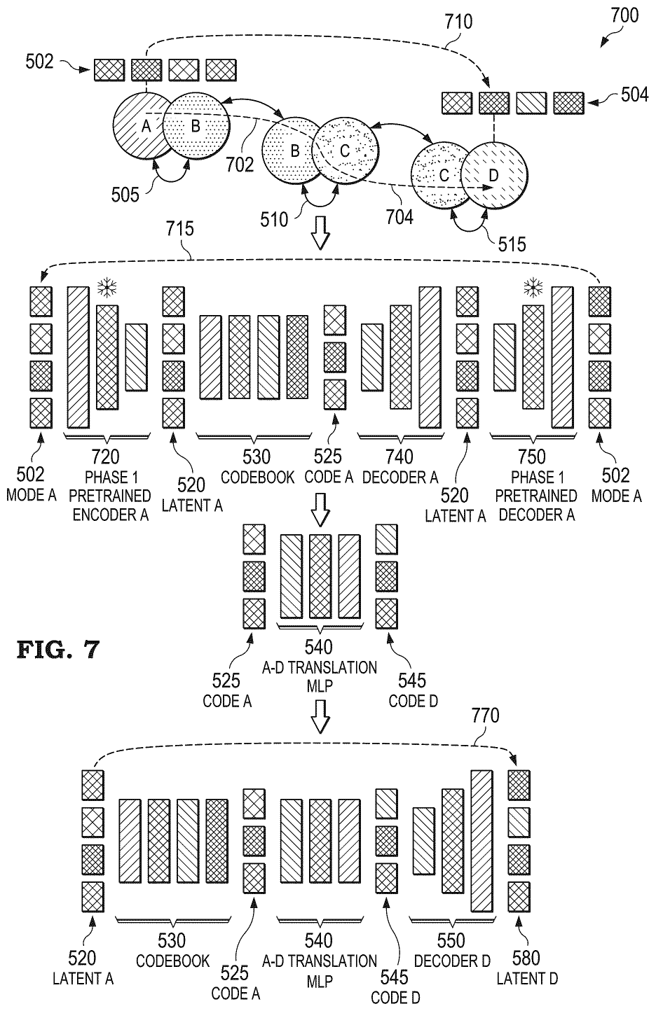

FIG. 7 illustrates a codebook optimization process 700 for optimized multimodal translation in accordance with some embodiments. In the depicted embodiment, the codebook optimization process 700 develops a vector-quantized cross-modal translation between different input modalities using four stages: sampling trajectories from one mode to another (data collection phase shown in top left); training a codebook for each mode (bottom left), training a network that predicts a vector-quantized code from one mode to another (top right), and then to vector-quantize an optimized translation codebook (bottom right), utilizing the network trained in the 3rd part to predict a code from another mode and then decoding it to get a mode representation.

The top left portion of FIG. 7 shows the data collection phase, and the desired optimized translation trajectory 710 from mode-A representation to mode-D representation, depicting the ideal direct translation that the system aims to achieve through the codebook optimization process 700.

During the data collection phase, mode translation trajectories 702 and 704 (between modes A to C and C to D, respectively) are sampled. Pretrained encoders from phase 1, such as phase 1 Pretrained Encoder A 720, and transformers from phase 2 are used to construct unforeseen data pairs. For example, to translate between mode A and mode D, the pretrained phase 1 Encoder A projects mode A into representation A, which is then transformed into representation B using the phase 2 A-B translation transformer 702. This process continues through trajectory 704 until representation D is reached, creating A-D data pairs for training the codebooks and Translation MLPs.

The bottom left portion of FIG. 7 illustrates the training and validation process for each mode's codebook and decoder, ensuring that the latent features are correctly encoded and decoded within the same mode, such as to maintain the integrity and accuracy of the encoded latent features before engaging in cross-modal translations.

The process begins with the input mode-A data 502, which is fed into the phase 1 Pretrained Encoder A 720. This encoder is responsible for transforming the raw mode-A data into a latent representation, referred to as latent mode-A representation 520. The latent representation captures the essential features and context of the input data in a high-dimensional space, making it suitable for further processing.

Next, the latent mode-A representation 520 is encoded into a mode-specific codebook, such as the mode-A codebook 530. This codebook stores quantized representations of the latent features specific to mode A. The quantization process involves mapping the high-dimensional latent features into a finite set of discrete vectors, called codebook entries. These quantized vectors facilitate efficient storage, retrieval, and translation between different modes by representing similar data points with common codes.

Once the latent features are quantized and stored in the codebook, the quantized codes 525 are decoded back into latent representations using Decoder A 740. This decoder reconstructs the latent mode-A representation 520 from the quantized codes stored in the mode-A codebook 530, such as to validate that the quantized codes accurately preserve the essential features and context of the original latent representation. The reconstructed latent mode-A representation is then compared to the original latent mode-A representation 520, such as to ensure the validity and accuracy of the quantized representations. This comparison is facilitated by the phase 1 Pretrained Decoder A 750, which decodes the quantized codes back into the original latent space. The consistency between the original and reconstructed latent representations ensures that the codebook accurately captures the necessary features for subsequent translations.

The top right portion of FIG. 7 depicts the training of the A-D Translation MLP 540 to predict a vector-quantized code from one mode (represented by code A 525) to another (represented by code D 545), leveraging the sampled data pairs to learn direct mappings between modes and bypassing the need for sequential translations through intermediate modes.

The bottom right portion of FIG. 7 integrates all components to vector-quantize a mode. The trained A-D Translation MLP 540 predicts a code from one mode, which is then decoded to obtain the target mode representation. This approach substantially optimizes the translation process, ensuring that the system can efficiently handle multimodal inputs and generate accurate, contextually relevant representations. The optimized translation path from the latent-A representation to the latent-D representation is indicated by trajectory 770.

By leveraging this multi-phase optimization process, the MMC can generate enhanced multimodal representations, efficiently translating between modalities using vector-quantized codes. The resulting representations are both accurate and contextually rich, providing a robust foundation for downstream tasks in the NPC generation system 200.

Again referencing FIG. 2, the Adaptive Multimodal Fuser (AMMF) 220 integrates and optimizes multimodal inputs to produce coherent and contextually rich outputs. In general, the AMMF 220 fuses diverse data modalities of multimodal input data 201 (e.g., text, audio, images, and/or sensor data) into a unified representation that can be effectively used by downstream tasks, including NPC behavior modeling and interaction generation.

Functionally, the AMMF employs a series of neural network architectures, including mixtures of experts (MoE) encoders and cross-attention mechanisms, to process and integrate inputs from different modalities, ensuring that each modality's unique features are preserved and utilized. The system begins by tokenizing and encoding the multimodal inputs into a common latent space. Through concatenation and subsequent MoE encoders, the data undergoes multiple layers of fusion, incorporating normalization and cross-attention layers to enhance the contextual understanding of the combined inputs. The final output is a refined, multimodal representation that encapsulates the relevant information from all input modalities.

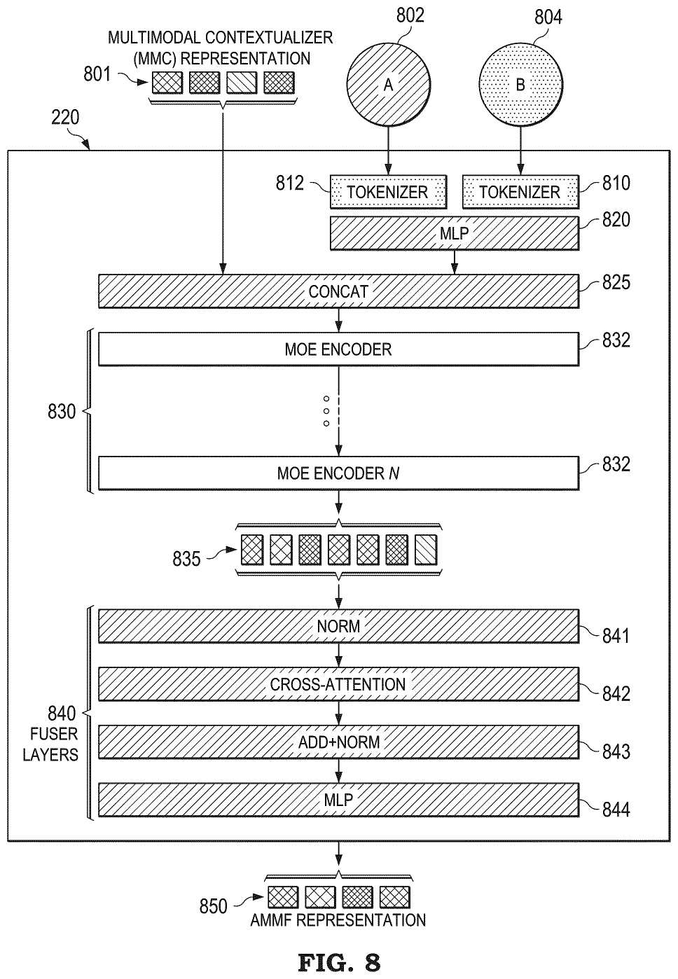

FIG. 8 illustrates the architecture of the AMMF 220, which integrates various data modalities—as fed from the MMC 215—to produce a unified and optimized multimodal representation. The AMMF is designed to handle complex inputs from different sources, ensuring efficient and accurate fusion of multimodal data.

The process begins with the AMMF 220 receiving MMC representation 801, which is output from the MMC 215 described elsewhere herein. Alongside the MMC representation, the system also receives raw modality inputs via the multimodal input data 201. In the example of FIG. 8, two modalities (labeled A 802 and B 804, which comprise any two sets of modal input data from the multimodal input data 201) are provided as input to the AMMF 220.

The modality inputs 802 and 804 are first processed by tokenizers 810 and 812, which convert the raw modal input data into tokenized representations suitable for further processing by the AMMF. In the depicted embodiment, tokenized representations from tokenizers 810 and 812 are then fed into a Multilayer Perceptron (MLP) block 820. The MLP block 820 performs feature transformation and nonlinear activation, learning complex patterns and representations within the input data.

The transformed outputs from the MLP 820 and the MMC representation 801 are then fed into the concatenation block 825. This concatenation step combines the diverse data modalities into a combined representation of the multimodal input data 802, 804 and the MMC representation 801 for processing by subsequent layers of the AMMF.

The combined representation is then passed through a series 830 of Mixture of Experts (MoE) encoders 832 to generate an intermediate representation 835 of the multimodal input data and the substantially disentangled latent representations. An MoE is a neural network in which a set of parameters are partitioned into disparate expert layers, each with a unique weight. During training and inference, the MoE encoder (and in particular a routing layer or router of the MoE encoder) routes input examples to specific expert layers and their respective weights. As a result, each input example only interacts with a subset of network parameters, contrasting the usual approach in which the entire neural network is used to process each input.

As used herein, a feature set refers to a collection of characteristics or attributes extracted from input data that are used to represent the data in a form suitable for analysis or processing by a machine learning model. The feature set includes various dimensions of information that capture the relevant aspects and patterns of the input data, enabling the model to learn and make predictions or decisions based on these features. The intermediate representation 835 has a feature set that is larger (e.g., broader and/or more detailed) than the respective input feature set of the multimodal input data 802, 804, of the MMC representation 801, or of the combined representation generated via concatenation block 825. Additionally, only a fraction of the expert layers are used for each example, such that the amount of computation remains relatively low with respect to the total model size. In general, the greater the quantity of MoE encoders 832 in the series 830, the greater the capability of the AMMF 220 to understand context, such as due to the larger feature set of the intermediate representation 835.

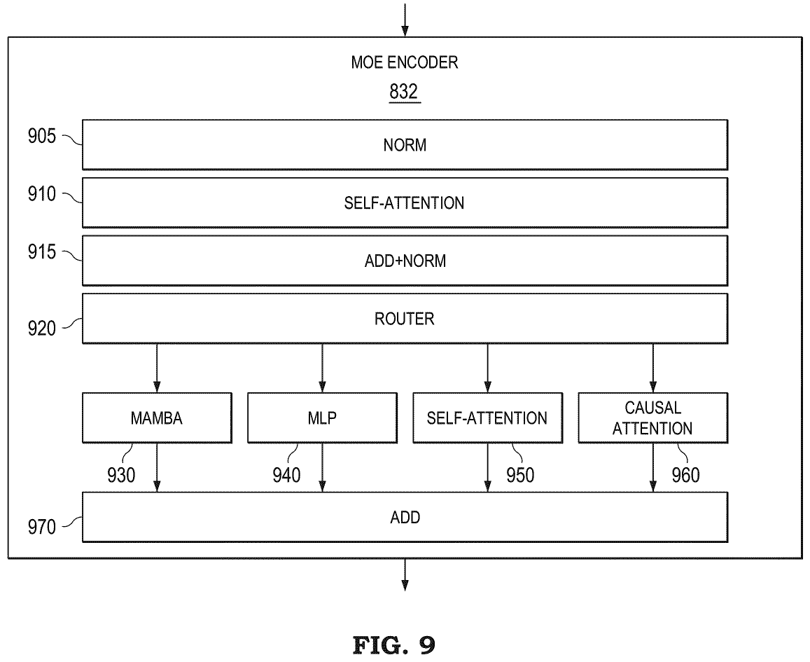

Thus, as described in greater detail with respect to FIG. 9 below, in various embodiments each MoE encoder processes the intermediate representation through multiple heterogeneous expert pathways, enhancing the system's ability to handle various data complexities and ensuring that the most relevant features are captured and utilized. The intermediate representation 835 is then forwarded to fuser layers 840.

Fuser layers 840 comprise multiple layers that further refine and integrate the multimodal data. In the depicted embodiment, these fuser layers 840 include a normalization layer 841, which standardizes the input data, ensuring that the subsequent layers receive data with consistent statistical properties; a cross-attention layer 842, which enables the model to focus on different parts of the input data by considering the interactions between multiple modalities or sequences; an additive & normalization layer 843, which combines the outputs from the cross-attention mechanism with the original input data through a residual connection, followed by normalization; and an MLP layer 844, which further processes the refined input data using multiple layers of neurons to capture complex patterns and relationships.

The output from the fuser layers 840 is an output AMMF representation 850, which is a fused multimodal representation of the multimodal input data 802, 804 and the substantially disentangled latent representations from the MMC representation 801. This representation 850 encapsulates the combined information from all input modalities, providing a rich, contextually relevant multimodal output that can be used for downstream tasks, such as NPC behavior modeling and interaction generation.

By merging diverse data types, the AMMF 220 enables the NPC generation processing system 200 to generate dynamic and interactive NPCs that can respond contextually to various stimuli. This integration leads to more realistic and engaging NPC interactions, as the fused representation allows for better interpretation and reaction to complex, real-world scenarios. Additionally, the fused outputs reduce computational overhead while improving performance, such as in real-time applications in which an NPC responds in real time to a player character or other user-controlled input.

FIG. 9 provides a detailed view of the Mixture of Experts (MoE) Encoder blocks 832 used within the AMMF 220 described in FIG. 8. The MoE Encoder 832 is responsible for processing and integrating multimodal inputs through multiple expert pathways, ensuring that the most relevant features are captured and utilized.

The process within the MoE Encoder begins with a normalization layer 905. This layer standardizes the input data, ensuring consistent statistical properties and making it easier for subsequent layers to process the data effectively. Following normalization, the data is fed into a self-attention layer 910, which enables the AMMF 220 to focus on different parts of the input data by computing attention scores that determine the importance of each element within the sequence, and improves the ability of the AMMF 220 to capture contextual relationships.

Next, the data passes through an add & normalize layer 915, which combines the output from the self-attention mechanism with the original input data through a residual connection and then normalizes the combined data. This process helps maintain the integrity of the original data while incorporating the enhancements from the self-attention mechanism.

The router 920 then directs the processed data to one or more of expert layers 930, 940, 950, 960. The router 920 dynamically assigns data to different expert layers based on the input characteristics, allowing the AMMF 220 to leverage the specialized processing capabilities of each expert layer. As used herein, an expert layer refers to a specialized neural network layer that is responsible for processing some or all of its input data, with each expert layer typically designed to handle one or more particular types of patterns or features in the input data. In certain embodiments, the router 920 dynamically assigns input data two different expert layers via a top-k routing function, which takes as input a token representation and then routes it to a top-k set of experts out of a larger plurality of experts. In certain embodiments, the output computation of the layer is a linearly weighted combination of each expert's computation on the token by the gate value, over the top-k selected experts.

In the depicted embodiment, the heterogeneous expert layers employed by the MoE encoder 832 include a mamba expert layer 930, such as to apply alternative approaches and operations to its input data compared to that provided by one or more attention or MLP operations from other expert layers in the MoE encoder 832. An MLP expert layer 940 transforms the input features into a higher-dimensional space through nonlinear activation functions, capturing complex relationships within the data. A self-attention expert layer 950, similar to the initial self-attention layer, further refines the data by focusing on different parts of the input sequence and computing attention scores to enhance contextual understanding. The causal attention expert layer 960 processes its input data by factoring in past outputs to predict a current output, making determinations auto-regressively based on that input data.

The outputs from expert layers 930, 940, 950, 960 are then combined via an additive layer 970. This layer aggregates the contributions from each expert pathway, integrating the diverse processing outputs into a coherent representation. The aggregated output is then passed as the output of the MoE encoder 832.

The architecture of the MoE Encoder 832, depicted in FIG. 9, highlights the capability of the AMMF 220 to process complex multimodal inputs through multiple specialized pathways. By leveraging the expert layers 930, 940, 950, 960, the MoE Encoder ensures that the most relevant features are captured and utilized, enhancing the overall performance and efficiency of the AMMF 220.

More generally, the AMMF architecture depicted in FIGS. 8 and 9 highlights the capability of the AMMF 220 to effectively merge diverse data types, enhancing the ability of the NPC generation system 200 to generate dynamic and interactive NPCs that can respond contextually to various stimuli. By leveraging its configuration of neural network layers and normalization techniques, the AMMF 220 ensures that the fused output of the AMMF representation 850 is both accurate and efficient.

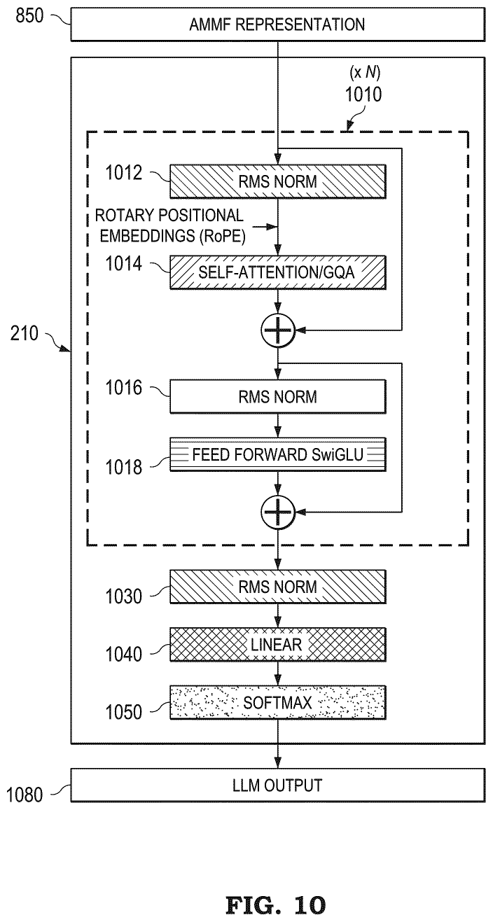

FIG. 10 illustrates an example architecture for a Large Language Model (LLM) 210 in accordance with some embodiments, which (with reference to FIG. 2) is provided input from the AMMF 220 via AMMF representation 850. In general, the LLM 210 processes the multimodal input data provided by the AMMF 220 to generate contextually relevant outputs by integrating and interpreting the fused multimodal data of the AMMF representation 850.

In the depicted embodiment, the AMMF representation 850 is input to the LLM 210 and is first processed by a series of N transformer blocks 1010, connected in series. In general, the greater N (and therefore the greater quantity of transformer blocks in series), the more capable are the models to understand context due to a larger receptive field. Each transformer block 1010 processes the data through a sequence of layers described below, progressively refining the input representation.

Within each transformer block 1010, an RMS normalization layer 1012 standardizes the input data from the AMMF representation 850. This normalization layer ensures consistent statistical properties, facilitating efficient processing by the subsequent layers. Following normalization, the data is passed to the self-attention/GQA (generalized query attention) layer 1014. In the depicted embodiment, the layer 1014 allows the model to focus on different parts of the input sequence, computing attention scores that determine the importance of each element.

The output of the self-attention/GQA layer 1014 is combined with the original input from the AMMF representation 850 through a residual addition operation, maintaining the original input information of the AMMF representation 850 while incorporating new information from the self-attention mechanism. The normalized and combined data is then fed into a feed-forward SwiGLU (switchable gated linear unit) layer 1018. This SwiGLU layer applies a feed-forward neural network with a switchable gating mechanism, allowing the model to capture complex patterns and relationships within the data.

The output of the feed-forward SwiGLU layer 1018 is then combined again via residual addition with the input provided to RMS normalization layer 1016, thereby creating the final output of the transformer block 1010.

Once the data from AMMF representation 850 has passed through all N transformer blocks 1010, it passes to a final RMS normalization layer 1030. As before, this layer ensures that its input data is consistently normalized before the final processing stages. The normalized data is then fed into a linear layer 1040, which applies a linear transformation to the data, mapping it to the appropriate output space.

A softmax layer applies the softmax function to its input data. The softmax function converts a vector of input data into a probability distribution, such that each element of the output vector represents the probability of a particular class. In the example architecture of LLM 210, a final softmax layer 1050 converts the output of linear layer 1040 into a probability distribution over a set of possible output tokens, generating the final output 1080 of the LLM 210. This LLM output 1080 represents the contextually relevant response generated by the LLM 210 based on the fused multimodal input data provided by the AMMF 220.

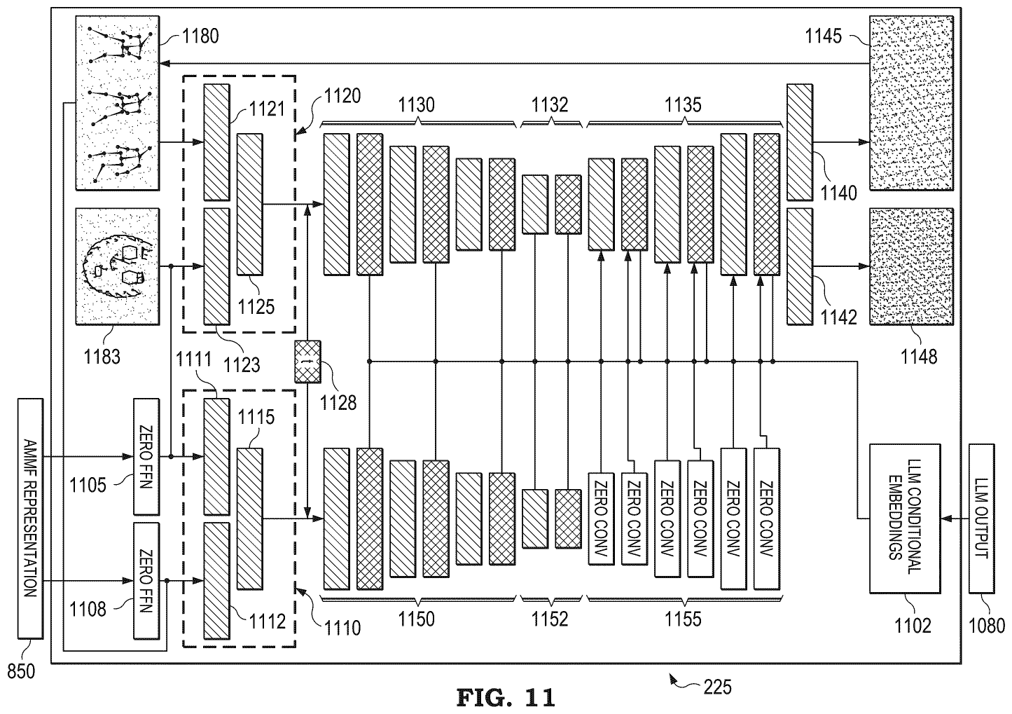

FIG. 11 illustrates an example structure and operations of the NPC-AI model 225 in accordance with some embodiments. The NPC-AI model 225 integrates output from the AMMF 220 and the LLM 210 (via the AMMF representation 850 and LLM output 1080) via a reverse diffusion process to generate detailed face vertex displacement data and joint trajectory data, respectively representing facial movements and motion trajectories for joints. The depicted embodiment utilizes a dual network structure, in which a one-dimensional (1D) U-Net effectuates the reverse diffusion process and is coupled to a control network structure that imposes constraints on that diffusion process, such as to ensure that the generated outputs satisfies certain conditions for the generated NPC.

In the depicted embodiment, the NPC-AI model 225 begins by processing the AMMF representation 850 via two zero-initialized Feed-Forward Networks (zero-FFNs) 1105 and 1108. As used herein, a zero-initialized Feed-Forward Network refers to a neural network in which weights of the network are initialized to zero at the start of training, such that the network begins with no prior bias towards any particular direction in the data. During training, the weights are updated based on the input data, gradually optimizing to capture the essential features and patterns within the data. In various embodiments of the NPC-AI model 225, zero-initialized Feed-Forward Networks are used to process initial input representations, providing a controlled and unbiased starting point for subsequent data transformations and refinements.

The zero-FFNs 1105, 1108 process the AMMF representation 850 to produce initial embeddings for a first stage of the transformer blocks 1110 and 1120. Separately, the LLM output 1080, which includes LLM contextual embeddings 1102 generated by the LLM 210, provides contextually enriched inputs to layers of the U-Net and control net, including encoder and decoder layers of those coupled networks.

The NPC-AI model 225 generates outputs that include facial vertex displacement data 1183 and joint trajectory data 1180. These outputs are produced through an iterative reverse diffusion process using initial noise data blocks 1145 and 1148, which are iteratively refined to produce the facial vertex displacement data 1183 and joint trajectory data 1180 based on the processed input data from AMMF representation 850 and LLM conditional embeddings 1102. The facial vertex displacement data 1183 and joint trajectory data 1180 are refined through a series of layers within the NPC-AI model. For example, in the depicted embodiment a first feature extraction and integration block 1120 comprises layers 1121, 1123, and 1125. Layer 1121 processes the joint trajectory data 1180 to extract relevant motion features, while layer 1123 processes the facial vertex displacement data 1183 to extract features related to facial movements. Layer 1125 integrates these extracted features, combining them into a unified representation. This integrated representation is enriched with temporal encoding from the time encoder 1128 and then fed into the U-Net encoder layers 1130.

Similarly, a second feature extraction and integration block 1110 comprises layers 1111, 1112, and 1115 to process and integrate the outputs from the zero-FFNs 1105, 1108 along with the facial vertex displacement data 1183 and joint trajectory data 1180. Layer 1110 processes the facial vertex displacement data 1183 and output from zero-FFN 1105, while layer 1112 processes the joint trajectory data 1180 and output from zero-FFN 1108. Layer 1115 combines these processed inputs, creating a unified representation that is fed into the control net encoder layers 1150.

The U-Net encoder layers 1130 encode the inputs from layer 1125 of the first feature extraction and integration block 1120 and the time encoder 1128. These encoded inputs are then fed into the U-Net encoder bottleneck 1132, which serves as a compressed representation of the data. The U-Net decoder layers 1135 then decode the compressed representations from the encoder bottleneck 1132, progressively refining the output. This iterative refinement happens over multiple passes, gradually reducing noise and enhancing the fidelity of the outputs. The refined outputs are then fed into component layers 1140 and 1142, which generally abstract the face vertices and body joints from their raw forms before being unified and processed.

The structure of the coupled control network (comprising in the depicted embodiment control net encoder layers 1150, control net bottleneck 1152, and control net decoder layers 1155) mirrors the U-Net structure, with control net encoder layers 1150 processing the inputs from the second feature extraction and integration block 1110 and the time encoder 1128. The encoded data from these layers is fed into the control net bottleneck 1152, which provides a compressed representation of that encoded data, and then into the control net decoder layers 1155.

In the depicted embodiment, the control net decoder layers 1155 are all zero-convolution layers, which decode the compressed representations from the control net bottleneck 1152, progressively refining the output through multiple iterations. These layers are coupled to the corresponding U-Net decoder layers 1135. As noted above, the general purpose of the control net is to impose constraints on the U-Net (1130, 1132, 1135) in order to satisfy various conditions. As part of this imposition, the zero-convolution control net decoder layers 1155 are primarily used for stability and to ensure the NPC-AI model 225 starts with minimal biases. These control net layers 1155 begin with weights initialized to zero, such that they initially pass the input data through without alteration. This initialization helps in stabilizing the training process by preventing large gradients that can cause the model to diverge. As training progresses, these layers learn to adjust their weights from zero, gradually introducing the necessary transformations to refine the output. In this manner, the network can focus on learning meaningful features rather than dealing with initial biases. In certain embodiments, this approach leads to a more stable and efficient convergence during the training process, ultimately improving the performance of the control net (1150, 1152, 1155) in generating accurate and contextually appropriate outputs.

Component layer 1140 receives output from the U-Net decoder layers 1135 and feeds into the first noise block 1145. The iterative reverse diffusion process refines the noise into coherent joint trajectory data 1180 over multiple passes through the U-Net and control net. Similarly, component layer 1142 receives output from the U-Net decoder layers 1135 and feeds into the second noise block 1148, which refines the noise into detailed facial vertex displacement data 1183 through iterative processing.

By integrating the AMMF representation 850 with the LLM conditional embeddings 1102 and leveraging the coupled U-Net and control network structure, the NPC-AI model 225 generates high-fidelity, contextually accurate face and body animations. The U-Net encoder-decoder layers (1130, 1132, 1135) work in tandem with the control net encoder-decoder layers (1150, 1152, 1155) to refine the processed multimodal input data (via AMMF representation 850 and LLM output 1080) to generate the joint trajectory data 1180 and facial vertex displacement data 1183. The iterative nature of this process ensures that the generated animations are both realistic and contextually relevant, providing a robust foundation for creating immersive NPC behaviors in digital environments.

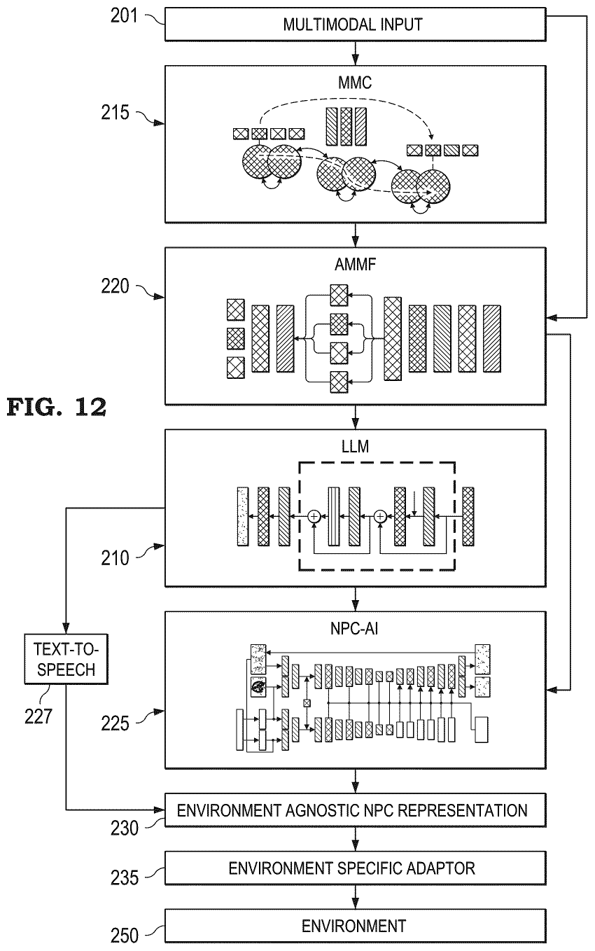

FIG. 12 illustrates an additional view of the NPC generation system 200 illustrated in FIG. 2, in accordance with some embodiments.

The environment-agnostic NPC representation 230 serves as intermediary between the outputs of NPC-AI model 225 and various environment-specific adapters 235. This representation 230 synthesizes the facial vertex displacement data 1183 and joint trajectory data 1180 produced by the NPC-AI model 225. The synthesized output is adaptable, allowing it to be rendered appropriately across one or more digital environments 250. As discussed elsewhere herein, in various embodiments and scenarios, may include, as a non-limiting examples: game engines, client edge devices, augmented reality (AR) and virtual reality (VR) systems, entertainment platforms, metaverse applications, etc. This adaptability ensures that the NPCs generated can interact realistically and contextually within a wide variety of such digital environments, maintaining high fidelity in their animations and interactions.

Additionally, output of the LLM 210 further enhances the interactivity and realism of the NPCs generated by the NPC generation system 200. The output from the LLM 210, including in various embodiments one or more language models and their associated contextual embeddings, is routed through the text-to-speech (TTS) block 227, which converts the LLM's textual output into spoken language. This spoken language is then integrated into the environment-agnostic NPC representation 230, enabling generated NPCs to engage in dynamic, context-aware conversations with users, responding in real-time to interactions and providing a seamless and immersive user experience.

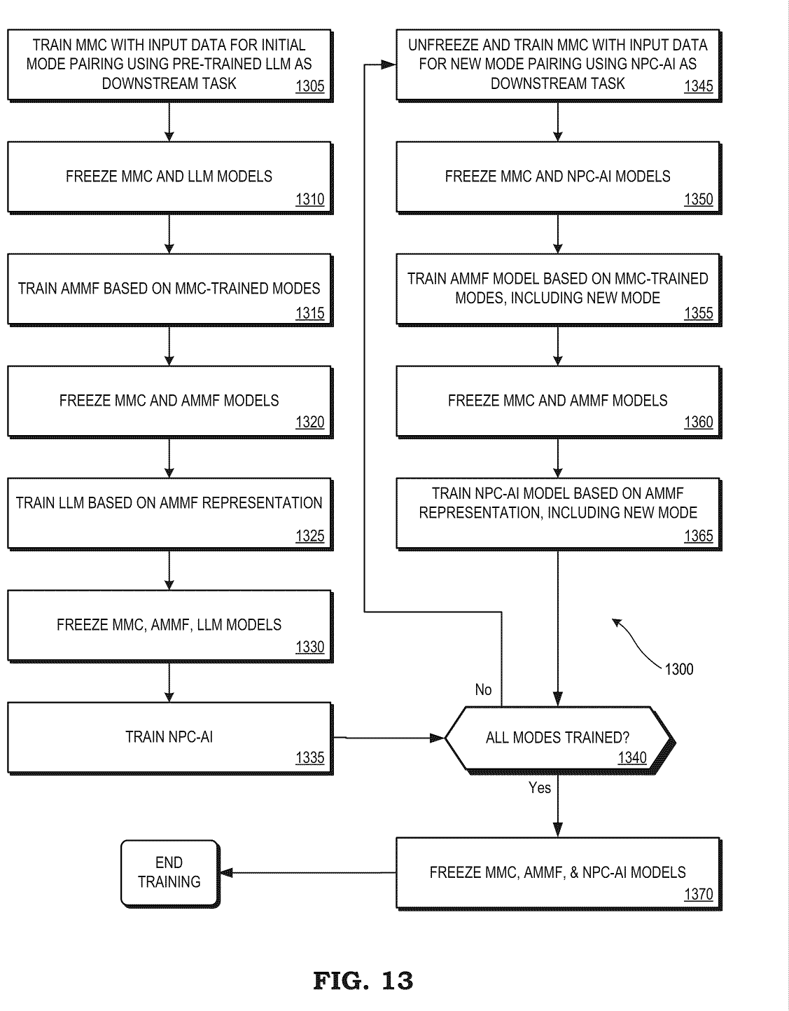

FIG. 13 illustrates an operational flow diagram of a training process 1300 for embodiments of an NPC generation system (e.g., NPC generation system 200 of FIGS. 2 and 12), in accordance with some embodiments. The training process 1300 encompasses both initial training stages and subsequent stages for incorporating new input modalities into the NPC generation system.

The training process 1300 begins with the training of an MMC (e.g., MMC 215 of FIGS. 2 and 12) with multimodal input data corresponding to an initial mode pairing (1305). As described elsewhere herein, in various embodiments and scenarios such input data includes various input modalities such as sensor data, images/videos, audio, and text. In various embodiments and scenarios, the initial mode pairing may be any combination of such input modalities. In the depicted embodiment, a pre-trained LLM serves as a downstream task for initial training of the MMC, guiding the integration of these initial input modes. Once the MMC has been trained on the initial mode pairing, both the MMC and LLM models are frozen (1310). As used herein, freezing of a model means that its parameters are fixed and will not be updated in subsequent training stages unless first unfrozen. This step ensures that the learned representations remain stable while the training process 1300 advances.

With the MMC and LLM models frozen, an Adaptive Multimodal Fuser (e.g., AMMF 220 of FIGS. 2 and 12) is trained using the representations generated by the MMC (1315). The AMMF integrates these multimodal representations, substantially optimizing them into a unified output. Following the training of the AMMF, both the MMC and AMMF models are frozen (1320). This step ensures that their parameters remain fixed and stable for subsequent training stages. The LLM is then trained using the integrated representations provided by the AMMF (1325). After the LLM has been trained, all three models (MMC, AMMF, and LLM) are frozen (1330), ensuring that their learned parameters are preserved and stable. The NPC-AI model is then trained (1335), refining the generated animations and interactions using the fixed representations from the previous stages. Following the training of the NPC-AI model, the training process 1300 determines (1340) whether any additional modes are to be trained in addition to those from the initial modality pairing.

If so, the MMC is unfrozen and trained using multimodal input data for the new mode pairing (1345). In contrast with the original training of the MMC in 1305, the now-trained NPC-AI model is used as the downstream task, guiding the integration of the new mode with the previously trained modes of the initial mode pairing. After training the MMC with the new mode pairing, both the MMC and NPC-AI models are frozen (1345). This ensures the stability of the previously learned representations while incorporating the new mode. The AMMF is then trained using the representations generated by the MMC, including the new mode (1350). This integrates the learned modes into a unified representation that now includes the additional mode. Once the AMMF training with the new mode is complete, both the MMC and AMMF models are frozen again (1360), maintaining the stability of the learned representations. The NPC-AI model is then trained using the integrated representations provided by the AMMF, ensuring that the NPC-AI can generate contextually accurate animations and interactions based on the fused multimodal data, including that corresponding to the new mode (1365).

In the depicted embodiment, the training process 1300 repeats steps 1345, 1350, 1355, 1360, and 1365 until it is determined (1340) that the MMC, AMMF, LLM, and NPC-AI models have been trained on all modes of the multimodal input data. If so, the MMC, AMMF, and NPC-AI models are frozen to maintain their learned parameters (1370). This freezing indicates the completion of the training process, such that the NPC generation system is ready to operate in inference mode, utilizing the fixed parameters to process new inputs and generate high-fidelity, contextually relevant NPC outputs.

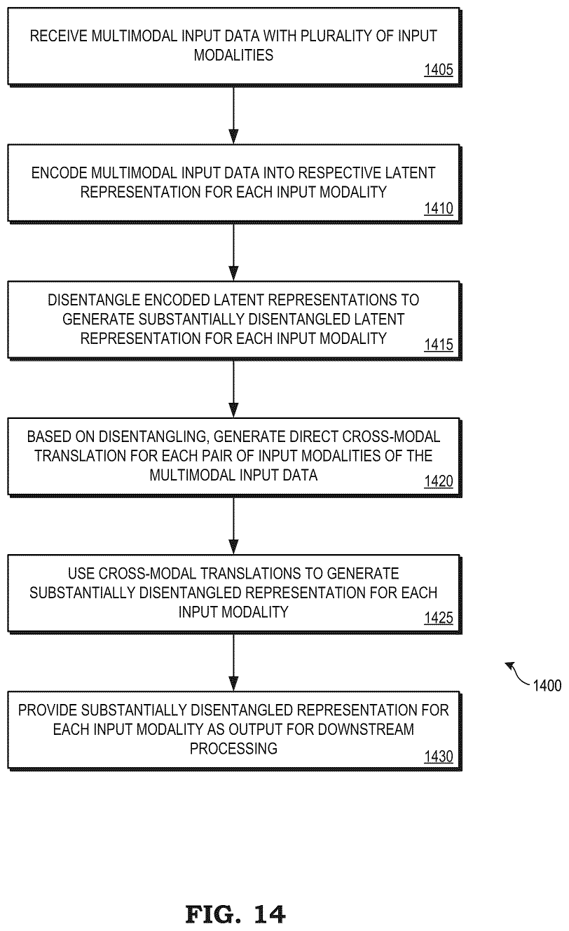

FIG. 14 illustrates a flow diagram of an operational routine 1400 for processing multimodal input data (e.g., multimodal input data 201 of FIGS. 2 and 12) to generate translated and disentangled representations for downstream processing, in accordance with some embodiments. The operational routine 1400 may be performed, for example, by one or more hardware processors executing an embodiment of a multimodal contextualizer such as MMC 215.

In the depicted embodiment, the operational routine 1400 begins at 1405, in which the MMC receives multimodal input data with a plurality of input modalities. Each modality provides distinct information that collectively represents the multimodal input data across different data types, such as sensor input data, graphical input data, audio input data, and textual input data. The routine then proceeds to 1410.

At 1410, the MMC encodes the multimodal input data into a respective latent representation for each input modality. This encoding process involves using pre-trained encoders specific to each modality to convert the input data into high-dimensional latent representations that capture the essential features and structure of the input data. The routine then proceeds to 1415.

At 1415, the MMC disentangles the encoded latent representations to generate a substantially disentangled latent representation corresponding to each input modality. This disentanglement process involves separating the encoded latent representations into distinct modality-specific feature spaces, ensuring that each representation accurately reflects the characteristics of its respective modality. The routine proceeds to 1420.

At 1420, based on the disentangling, the MMC generates a direct cross-modal translation for each pair of input modalities of the multimodal input data. This involves learning cross-modal relationships between the paired latent representations and optimizing the translation process to ensure accurate and efficient translation between different modalities. The routine proceeds to 1425.

At 1425, the MMC uses the cross-modal translations to generate a translated and disentangled representation for each input modality. This step leverages the learned cross-modal relationships to produce representations that maintain the essential features of each modality while enabling coherent integration with other modalities. The routine then proceeds to 1430.

At 1430, the MMC provides the translated and disentangled representation for each input modality as output for downstream processing. The generated representations can be used in various applications, such as generating high-fidelity animations and interactions for non-player characters (NPCs) in digital environments, improving the overall user experience.

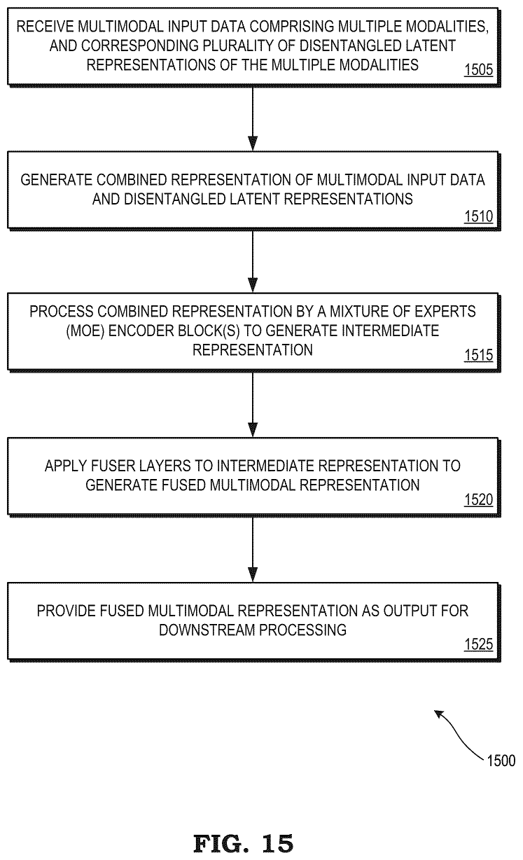

FIG. 15 illustrates a flow diagram of an operational routine 1500 for processing multimodal input data (e.g., multimodal input data 201 of FIGS. 2 and 12) to generate a fused multimodal representation of that input data for downstream processing, in accordance with some embodiments. The operational routine 1500 may be performed, for example, by one or more hardware processors executing an embodiment of an adaptive multimodal fuser such as AMMF 220.

In the depicted embodiment, the operational routine 1500 begins at 1505, in which the AMMF receives multimodal input data comprising multiple modalities and a corresponding plurality of disentangled latent representations of the multiple modalities (such as those generated by an MMC based on the input data). The routine then proceeds to 1510.

At 1510, the AMMF generates a combined representation of the multimodal input data and the disentangled latent representations. This combined representation integrates the raw multimodal input data with its corresponding latent representations, capturing the essential features and structure of the input data in a unified form. The routine then proceeds to 1515.

At 1515, the AMMF processes the combined representation through one or more Mixture of Experts (MoE) encoder blocks to generate an intermediate representation. These MoE encoder blocks leverage multiple expert layers to transform the combined representation, extracting and integrating relevant features from the multimodal input data. The routine then proceeds to 1520.

At 1520, the AMMF applies a sequence of fuser layers to the intermediate representation to generate a fused multimodal representation. The fuser layers perform further integration and refinement of the intermediate representation, ensuring that the fused multimodal representation accurately reflects the combined information from all input modalities. The routine then proceeds to 1525.

At 1525, the AMMF provides the fused multimodal representation as output for downstream processing. The generated fused multimodal representation can be used in various applications, such as generating high-fidelity animations and interactions for non-player characters (NPCs) in virtual digital environments, improving the overall user experience.

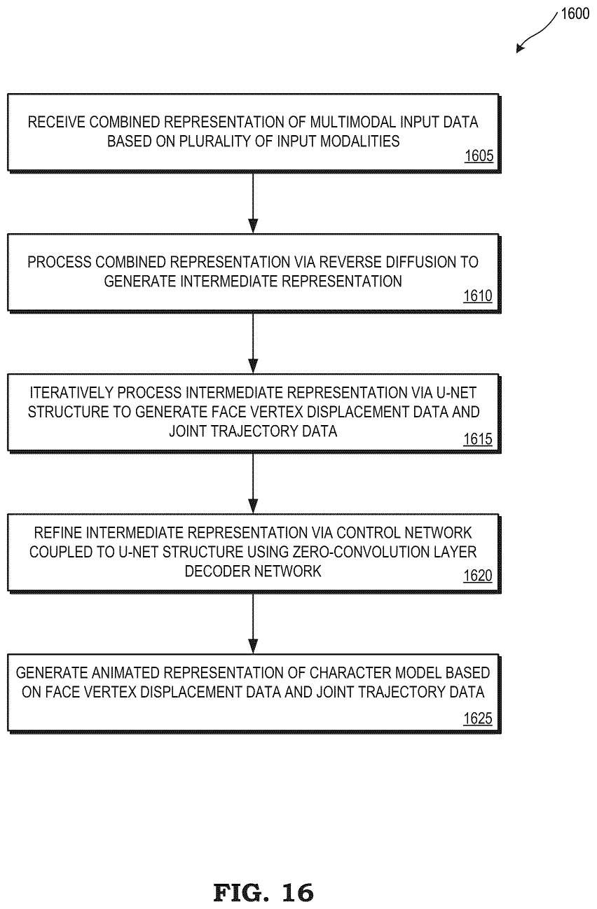

FIG. 16 illustrates a flow diagram of an operational routine 1600 for generating an animated representation of a character model, in accordance with one or more embodiments. The operational routine 1600 may be performed, for example, by one or more hardware processors executing an embodiment of an NPC-AI model (e.g., NPC-AI model 225 of FIGS. 2 and 12).

In the depicted embodiment, the operational routine 1600 begins at 1605, in which the NPC-AI receives a combined representation of multimodal input data based on a plurality of input modalities. This combined representation integrates the raw multimodal input data with its corresponding latent representations, capturing the essential features and structure of the input data in a unified form. The routine then proceeds to 1610.

At block 1610, the NPC-AI processes the combined representation via reverse diffusion to generate an intermediate representation. Reverse diffusion involves initializing the combined representation with noise and iteratively refining it to reduce the noise and enhance feature details, effectively denoising the intermediate representation to reveal meaningful patterns. The routine proceeds to 1615.

At 1615, the intermediate representation is iteratively processed via a U-Net structure of the to generate face vertex displacement data and joint trajectory data for the character model. In various embodiments, the U-Net structure includes encoder and decoder layers with skip connections, allowing detailed feature information to be transferred directly from the encoder to the decoder, thus preserving high-resolution details in the generated data. The routine then proceeds to 1620.

At block 1620, the intermediate representation is refined via a control network coupled to the U-Net structure using a zero-convolution layer decoder network. The control network aids in the refinement process, ensuring that the generated data is accurate and contextually relevant. The routine then proceeds to 1625.

At 1625, the refined face vertex displacement data and joint trajectory data are used to generate an animated representation of the character model. This animated representation is based on the refined data, ensuring realistic and contextually appropriate animations for the character model. In certain embodiments, the animated representation may be provided to one or more environment-specific adapters (e.g., environment-specific adapters 235 of FIGS. 2 and 12) to animate an NPC associated with the character model within one or more virtual digital environments.

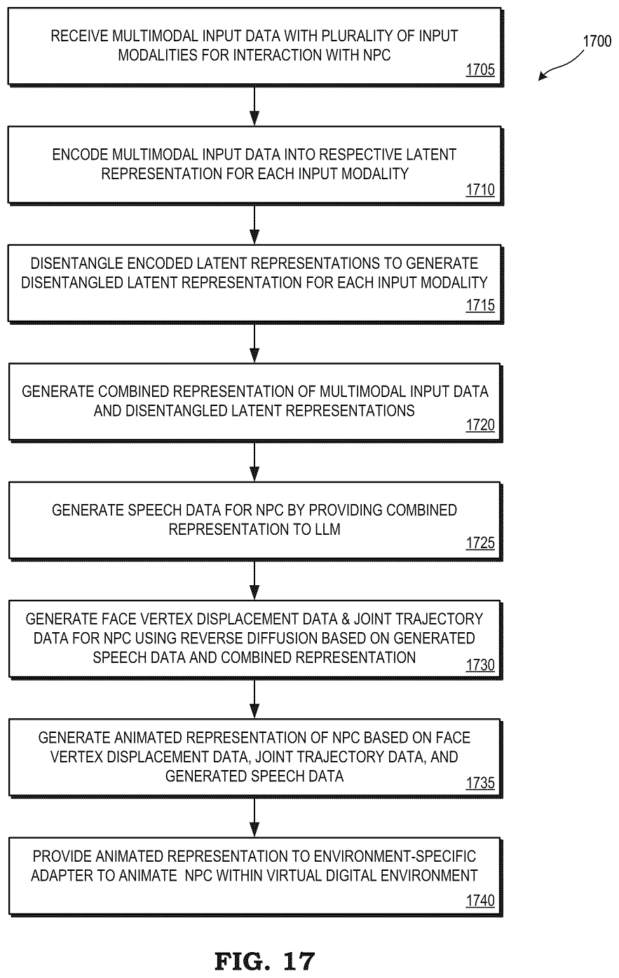

FIG. 17 illustrates a flow diagram of an operational routine 1700 for generating an animated representation of an NPC within a virtual digital environment, in accordance with one or more embodiments. The operational routine 1700 may be performed, for example, by one or more hardware processors executing an embodiment of an NPC generation system (e.g., NPC generation system 200 of FIGS. 2 and 12).

In the depicted embodiment, the operational routine 1700 begins at 1705, in which the system receives multimodal input data with a plurality of input modalities for interaction with the NPC. This multimodal input data can include text, image, depth map, heat map, and sensor data, each modality contributing specific contextual and structural information about the environment and interaction. The routine then proceeds to 1710.

At 1710, the system encodes the multimodal input data into a respective latent representation for each input modality. In certain embodiments, this encoding process leverages pre-trained encoders to transform each modality's input data into high-dimensional latent representations that capture essential features and structure. The routine proceeds to 1715.

At 1715, the system disentangles the encoded latent representations to generate a substantially disentangled latent representation corresponding to each input modality. The disentanglement process ensures that the unique features of each modality are preserved and separated from those of other modalities, resulting in distinct and independent latent representations. The routine proceeds to 1720.

At 1720, the system generates a combined representation of the multimodal input data and the disentangled latent representations. This combined representation integrates the raw input data with its corresponding disentangled latent features, forming a unified representation that captures the comprehensive information of the multimodal input data. The routine then proceeds to 1725.

At 1725, the system generates speech data for the NPC by providing the combined representation to a large language model (LLM). The LLM processes the combined representation to produce contextually relevant and coherent speech data, which can be used to animate the NPC's dialogue and vocal interactions within the virtual environment. The routine proceeds to 1730.

At 1730, the system generates face vertex displacement data and joint trajectory data for the NPC using reverse diffusion based on the generated speech data and the combined representation. The reverse diffusion process iteratively refines the combined representation, enhancing the feature details and reducing noise to produce accurate and detailed animation data for the NPC's facial and body movements. The routine proceeds to 1735.

At 1735, the system generates an animated representation of the NPC based on the face vertex displacement data, joint trajectory data, and generated speech data. This animated representation ensures that the NPC's movements and interactions are realistic, contextually appropriate, and synchronized with the generated speech data. The routine then proceeds to 1740.

At block 1740, the system provides the animated representation to an environment-specific adapter to animate the NPC within a virtual digital environment associated with the environment-specific adapter. The environment-specific adapter ensures that the NPC's animations are seamlessly integrated into the virtual digital environment, enabling interactive and immersive experiences for users.

### BRIEF SUMMARY OF SELECTED EMBODIMENTS

In embodiments, a method comprises receiving multimodal input data comprising a plurality of input modalities; encoding the multimodal input data into a respective latent representation for each input modality of the plurality of input modalities; disentangling the encoded latent representations to generate a substantially disentangled latent representation corresponding to each input modality of the plurality of input modalities; and, based on the disentangling, generating a direct cross-modal translation for each pair of input modalities in the multimodal input data.

The method may further comprise using the cross-modal translations to generate a substantially disentangled representation of each input modality of the multimodal input data for use in subsequent processing.

Generating the direct cross-modal translation may comprise generating a modality translation codebook mapping a direct modality translation between a pair of input modalities. Generating the modality translation codebook may comprise collecting data pairs from the latent representations of the input modalities; training a neural network to map the latent representation of one input modality to the latent representation of another input modality; quantizing the mapped latent representations into discrete vectors; and storing the discrete vectors in the modality translation codebook to represent the direct translation between the pair of input modalities.

Encoding the multimodal input data into a respective latent representation for each input modality may comprise encoding the multimodal input data into a continuous latent space, such that disentangling the encoded latent representations includes disentangling the encoded latent representations into a modality-specific feature space for each input modality of the plurality of input modalities.

Disentangling the encoded latent representations to generate a substantially disentangled latent representation corresponding to each input modality may comprise iteratively pairing the respective latent representations for each input modality of the plurality of input modalities; and learning one or more cross-modal relationships between the paired latent representations.

The method may further comprise using reconstruction loss between the respective latent representation for an input modality and the substantially disentangled latent representation corresponding to that input modality to optimize the substantially disentangled latent representation.

Encoding the multimodal input data into a respective latent representation for each input modality may comprise using a respective pre-trained encoder for each input modality to encode the latent representation.

In embodiments, a system comprises one or more processors executing one or more convolutional and/or other neural networks, and one or more memories for storing multimodal input data comprising a plurality of input modalities. The one or more neural networks are configured to encode the multimodal input data into a respective latent representation for each input modality of the plurality of input modalities; disentangle the encoded latent representations to generate a substantially disentangled latent representation corresponding to each input modality of the plurality of input modalities; and, based on the substantially disentangled latent representations, generate a direct cross-modal translation for each pair of input modalities in the multimodal input data.

The one or more neural networks may be configured to utilize the cross-modal translations to generate a substantially disentangled representation of each input modality of the multimodal input data for use in subsequent processing.

Generating a direct cross-modal translation may comprise generating a modality translation codebook mapping a direct modality translation between a pair of input modalities. Generating the modality translation codebook may comprise collecting data pairs from the latent representations of the input modalities; training a neural network to map the latent representation of one input modality to the latent representation of another input modality; quantizing the mapped latent representations into discrete vectors; and storing the discrete vectors in the modality translation codebook to represent the direct translation between the pair of input modalities.

Encoding the multimodal input data into a respective latent representation for each input modality may comprise encoding the multimodal input data into a continuous latent space, such that disentangling the encoded latent representations includes disentangling the encoded latent representations into a modality-specific feature space for each input modality of the plurality of input modalities.

Disentangling the encoded latent representations to generate a substantially disentangled latent representation corresponding to each input modality may include iteratively pairing the respective latent representations for each input modality of the plurality of input modalities; and learning one or more cross-modal relationships between the paired latent representations.

The one or more neural networks may be configured to use reconstruction loss between the respective latent representation for an input modality and the substantially disentangled latent representation corresponding to that input modality to optimize the substantially disentangled latent representation.

Encoding the multimodal input data into a respective latent representation for each input modality may comprise utilizing a respective pre-trained encoder for each input modality to encode the latent representation.

In embodiments, a non-transitory computer-readable medium stores executable instructions that, when executed by one or more processors, cause the one or more processors to execute one or more neural networks. The neural networks are configured to receive multimodal input data comprising a plurality of input modalities; to encode the multimodal input data into a respective latent representation for each input modality of the plurality of input modalities; to disentangle the encoded latent representations to generate a substantially disentangled latent representation corresponding to each input modality of the plurality of input modalities; and, based on the substantially disentangled latent representations, to generate a direct cross-modal translation for each pair of input modalities in the multimodal input data.

The one or more neural networks may be configured to utilize the cross-modal translations to generate a substantially disentangled representation of each input modality of the multimodal input data for use in subsequent processing.

The one or more neural networks may be configured to use reconstruction loss between the respective latent representation for an input modality and the substantially disentangled latent representation corresponding to that input modality to optimize the substantially disentangled latent representation.

Encoding the multimodal input data into a respective latent representation for each input modality may comprise using a respective pre-trained encoder for each input modality to encode the latent representation.

In embodiments, a method comprises receiving multimodal input data comprising a plurality of input modalities, and a corresponding plurality of substantially disentangled latent representations of the input modalities; generating a combined representation of the multimodal input data and the substantially disentangled latent representations; processing the combined representation via one or more Mixture of Experts (MoE) encoders to generate an intermediate representation; applying one or more fuser layers to the intermediate representation to generate a fused multimodal representation of the multimodal input data and the substantially disentangled latent representations; and providing the fused multimodal representation as output for downstream processing.

Each MoE encoder block may comprise a router layer and a plurality of expert layers. For at least one MoE encoder block, processing the combined representation may comprise determining, by the router layer of the at least one MoE encoder block, to provide the combined representation to a subset of the plurality of expert layers of the at least one MoE encoder block.

Generating the combined representation may comprise tokenizing the multimodal input data to generate mode-specific tokenized representations of the multimodal input data; and processing the tokenized representation of the multimodal input data by one or more processing layers. Generating the combined representation may further comprise concatenating the substantially disentangled latent representations with the processed tokenized representations of the multimodal input data.

Processing the combined representation via the one or more MoE encoders may comprise processing the combined representation through multiple MoE encoders in series.

Applying a sequence of fuser layers to the intermediate representation may comprise applying to the intermediate representation one or more of a group that includes a normalization layer, a cross-attention layer, or a multilayer perceptron (MLP).

In embodiments, a system comprises one or more processors executing one or more neural networks, and one or more memories to store multimodal input data comprising a plurality of input modalities, and to store a corresponding plurality of substantially disentangled latent representations of the input modalities. The one or more neural networks are configured to generate a combined representation of the multimodal input data and the substantially disentangled latent representations; process the combined representation via one or more Mixture of Experts (MoE) encoder blocks to generate an intermediate representation; apply one or more fuser layers to the intermediate representation to generate a fused multimodal representation of the multimodal input data and the substantially disentangled latent representations; and provide the fused multimodal representation as output for downstream processing.

Each MoE encoder block may comprise a router layer and a plurality of expert layers. For at least one MoE encoder block, to process the combined representation may comprise to determine, by the router layer of the at least one MoE encoder block, to provide the combined representation to a subset of the plurality of expert layers of the at least one MoE encoder block.

To generate the combined representation may comprise to tokenize the multimodal input data to generate mode-specific tokenized representations of the multimodal input data; and to process the tokenized representation of the multimodal input data by one or more processing layers. Generating the combined representation may further comprise to concatenate the substantially disentangled latent representations with the processed tokenized representations of the multimodal input data.

To process the combined representation via the one or more MoE encoder blocks may comprise to process the combined representation through multiple MoE encoder blocks in series.

To apply the one or more fuser layers to the intermediate representation may comprise to apply to the intermediate representation one or more of a group that includes a normalization layer, a cross-attention layer, or a multilayer perceptron (MLP).

In embodiments, a non-transitory computer-readable medium stores executable instructions that, when executed by one or more processors, cause the one or more processors to execute one or more neural networks configured to generate a combined representation of the multimodal input data and the substantially disentangled latent representations; process the combined representation via one or more Mixture of Experts (MoE) encoders to generate an intermediate representation; apply one or more fuser layers to the intermediate representation to generate a fused multimodal representation of the multimodal input data and the substantially disentangled latent representations; and provide the fused multimodal representation as output for downstream processing.

Each MoE encoder block may comprise a router layer and a plurality of expert layers. For at least one MoE encoder block, to process the combined representation may comprise to determine, by the router layer of the at least one MoE encoder block, to provide the combined representation to a subset of the plurality of expert layers of the at least one MoE encoder block.

To generate the combined representation may include to tokenize the multimodal input data to generate mode-specific tokenized representations of the multimodal input data; and to process the tokenized representation of the multimodal input data by one or more processing layers. Generating the combined representation may further comprise to concatenate the substantially disentangled latent representations with the processed tokenized representations of the multimodal input data.

To process the combined representation via the one or more MoE encoder blocks may comprise to process the combined representation through multiple MoE encoder blocks in series.

To apply the one or more fuser layers to the intermediate representation may comprise to apply to the intermediate representation one or more of a group that includes a normalization layer, a cross-attention layer, or a multilayer perceptron (MLP).

In embodiments, a method comprises receiving a combined representation of multimodal input data based on a plurality of input modalities; processing the combined representation via reverse diffusion to generate an intermediate representation; and iteratively processing the intermediate representation via a U-Net structure to generate face vertex displacement data and joint trajectory data for a character model.

Receiving the combined representation of multimodal input data may comprise receiving a fused multimodal representation of the multimodal input data and of a corresponding plurality of substantially disentangled latent representations of input modalities of the multimodal input data.

Iteratively processing the intermediate representation via a U-Net structure may comprise refining the intermediate representation via a control network coupled to the U-Net structure, the control network comprising a decoder network having a plurality of zero-convolution layers.

The method may further comprise receiving generated speech data from a large language model (LLM), the generated speech data being output by the LLM based on the combined representation of multimodal input data.

Processing the combined representation may comprise applying a time encoder to the combined representation to incorporate temporal information into the intermediate representation.

The method may further comprise generating one or more animation sequences for the character model by generating an animated representation of the character model based at least in part on the face vertex displacement data and the joint trajectory data; and providing the animated representation to an environment-specific adapter to animate the character model within a virtual digital environment corresponding to the environment-specific adapter.

In embodiments, a system comprises one or more processors executing one or more neural networks, and one or more memories to store a combined representation of multimodal input data based on a plurality of input modalities. The one or more neural networks are configured to process the combined representation via reverse diffusion to generate an intermediate representation; and iteratively process the intermediate representation via a U-Net structure to generate face vertex displacement data and joint trajectory data for a character model.

The combined representation of multimodal input data may comprise a fused multimodal representation of the multimodal input data and of a corresponding plurality of substantially disentangled latent representations of input modalities of the multimodal input data.

To iteratively process the intermediate representation via the U-Net structure may comprise refining the intermediate representation via a control network coupled to the U-Net structure, the control network comprising a decoder network having a plurality of zero-convolution layers.

The system may further comprise receiving generated speech data from a large language model (LLM) based on the combined representation.

To process the combined representation may comprise to apply a time encoder to the combined representation to incorporate temporal information into the intermediate representation.

The one or more neural networks may be configured to generate one or more animation sequences for the character model by generating an animated representation of the character model based at least in part on the face vertex displacement data and the joint trajectory data; and providing the animated representation to an environment-specific adapter to animate the character model within a virtual digital environment corresponding to the environment-specific adapter.

In embodiments, a method comprises receiving multimodal input data comprising a plurality of input modalities for interaction with a non-player character (NPC) in a virtual digital environment, the NPC having a set of body features and a set of facial features; providing the multimodal input data as input to one or more neural networks; and, based on output of the one or more neural networks in response to the multimodal input data, generating one or more animation sequences for both the set of body features and the set of facial features.

The method may further comprise disentangling, via the one or more neural networks, a set of encoded latent representations of the plurality of input modalities to generate a substantially disentangled latent representation corresponding to each input modality of the plurality of input modalities; generating, via the one or more neural networks, a combined representation of the multimodal input data and the substantially disentangled latent representations; and generating, via the one or more neural networks, speech data for the NPC based on providing the combined representation to a large-language model (LLM).

The method may further comprise generating, via the one or more neural networks and using reverse diffusion, face vertex displacement data and joint trajectory data for the NPC based at least in part on the generated speech data and on the combined representation.

Generating the one or more animation sequences may comprise generating an animated representation of the NPC based at least in part on the face vertex displacement data, the joint trajectory data, and the generated speech data; and providing the animated representation to one or more environment-specific adapters to animate the NPC within the virtual digital environment.

In embodiments, a system comprises one or more processors executing one or more neural networks, and one or more memories for storing multimodal input data comprising a plurality of input modalities for interaction with a non-player character (NPC) in a virtual digital environment, the NPC having a set of body features and a set of facial features. The one or more neural networks are configured to generate one or more animation sequences for both the set of body features and the set of facial features based on the multimodal input data.

The one or more neural networks may be configured to disentangle a set of encoded latent representations of the plurality of input modalities to generate a substantially disentangled latent representation corresponding to each input modality of the plurality of input modalities; generate a combined representation of the multimodal input data and the substantially disentangled latent representations; and generate speech data for the NPC based on providing the combined representation to a large-language model (LLM).

The one or more neural networks may be configured to generate, using reverse diffusion, face vertex displacement data and joint trajectory data for the NPC based at least in part on the generated speech data and on the combined representation.

The one or more neural networks may be configured to generate an animated representation of the NPC based at least in part on the face vertex displacement data, the joint trajectory data, and the generated speech data; and provide the animated representation to one or more environment-specific adapters to animate the NPC within the virtual digital environment.

In some embodiments, the apparatus and techniques described above are implemented in a system including one or more integrated circuit (IC) devices (also referred to as integrated circuit packages or microchips), such as the fused NPC generation based on multimodal input described with reference to FIGS. 1-17. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” etc.) are described or claimed as “configured” to perform one or more tasks or operations. This formulation— [entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
receiving a combined representation of multimodal input data based on a plurality of input modalities;
processing the combined representation via reverse diffusion to generate an intermediate representation; and
iteratively processing the intermediate representation via a U-Net structure to generate face vertex displacement data and joint trajectory data for a character model.

2. The method of claim 1, wherein receiving the combined representation of multimodal input data comprises receiving a fused multimodal representation of the multimodal input data and of a corresponding plurality of substantially disentangled latent representations of input modalities of the multimodal input data.

3. The method of claim 1, wherein iteratively processing the intermediate representation via a U-Net structure comprises refining the intermediate representation via a control network coupled to the U-Net structure, the control network comprising a decoder network having a plurality of zero-convolution layers.

4. The method of claim 1, further comprising receiving generated speech data from a large language model (LLM), the generated speech data being output by the LLM based on the combined representation of multimodal input data.

5. The method of claim 1, wherein processing the combined representation comprises applying a time encoder to the combined representation to incorporate temporal information into the intermediate representation.

6. The method of claim 1, further comprising generating one or more animation sequences for the character model by:
generating an animated representation of the character model based at least in part on the face vertex displacement data and the joint trajectory data; and
providing the animated representation to an environment-specific adapter to animate the character model within a virtual digital environment corresponding to the environment-specific adapter.

7. A system, comprising:
one or more processors executing one or more neural networks; and
one or more memories to store a combined representation of multimodal input data based on a plurality of input modalities;
wherein the one or more neural networks are configured to:
process the combined representation via reverse diffusion to generate an intermediate representation; and
iteratively process the intermediate representation via a U-Net structure to generate face vertex displacement data and joint trajectory data for a character model.

8. The system of claim 7, wherein the combined representation of multimodal input data comprises a fused multimodal representation of the multimodal input data and of a corresponding plurality of substantially disentangled latent representations of input modalities of the multimodal input data.

9. The system of claim 7, wherein to iteratively process the intermediate representation via the U-Net structure comprises refining the intermediate representation via a control network coupled to the U-Net structure, the control network comprising a decoder network having a plurality of zero-convolution layers.

10. The system of claim 7, further comprising receiving generated speech data from a large language model (LLM) based on the combined representation.

11. The system of claim 7, wherein to process the combined representation comprises to apply a time encoder to the combined representation to incorporate temporal information into the intermediate representation.

12. The system of claim 7, wherein the one or more neural networks are configured to
generate one or more animation sequences for the character model by:
generating an animated representation of the character model based at least in part on the face vertex displacement data and the joint trajectory data; and
providing the animated representation to an environment-specific adapter to animate the character model within a virtual digital environment corresponding to the environment-specific adapter.

13. A method comprising:
receiving multimodal input data comprising a plurality of input modalities for interaction with a non-player character (NPC) in a virtual digital environment, the NPC having a set of body features and a set of facial features;
providing the multimodal input data as input to one or more neural networks; and
based on output of the one or more neural networks in response to the multimodal input data, generating one or more animation sequences for both the set of body features and the set of facial features.

14. The method of claim 13, further comprising:
disentangling, via the one or more neural networks, a set of encoded latent representations of the plurality of input modalities to generate a substantially disentangled latent representation corresponding to each input modality of the plurality of input modalities;
generating, via the one or more neural networks, a combined representation of the multimodal input data and the substantially disentangled latent representations; and
generating, via the one or more neural networks, speech data for the NPC based on providing the combined representation to a large-language model (LLM).

15. The method of claim 14, further comprising:
generating, via the one or more neural networks and using reverse diffusion, face vertex displacement data and joint trajectory data for the NPC based at least in part on the generated speech data and on the combined representation.

16. The method of claim 15, wherein generating the one or more animation sequences comprises:
generating an animated representation of the NPC based at least in part on the face vertex displacement data, the joint trajectory data, and the generated speech data; and
providing the animated representation to one or more environment-specific adapters to animate the NPC within the virtual digital environment.

17. A system, comprising:
one or more processors executing one or more neural networks; and
one or more memories for storing multimodal input data comprising a plurality of input modalities for interaction with a non-player character (NPC) in a virtual digital environment, the NPC having a set of body features and a set of facial features;
wherein the one or more neural networks are configured to generate one or more animation sequences for both the set of body features and the set of facial features based on the multimodal input data.

18. The system of claim 17, wherein the one or more neural networks are configured to:
disentangle a set of encoded latent representations of the plurality of input modalities to generate a substantially disentangled latent representation corresponding to each input modality of the plurality of input modalities;
generate a combined representation of the multimodal input data and the substantially disentangled latent representations; and
generate speech data for the NPC based on providing the combined representation to a large-language model (LLM).

19. The system of claim 18, wherein the one or more neural networks are configured to:
generate, using reverse diffusion, face vertex displacement data and joint trajectory data for the NPC based at least in part on the generated speech data and on the combined representation.

20. The system of claim 19, wherein the one or more neural networks are configured to:
generate an animated representation of the NPC based at least in part on the face vertex displacement data, the joint trajectory data, and the generated speech data; and
provide the animated representation to one or more environment-specific adapters to animate the NPC within the virtual digital environment.
